(19) United States
(12) Patent Application Publication
(10) Pub. No.: US 2026/0346441 A1
(43) Pub. Date: Nov. 5, 2026

(54) CONTROL DEVICE, NON-TRANSITORY STORAGE MEDIUM AND CONTROL METHOD

(71) Applicant: OMRON Corporation, Kyoto-shi, KYOTO (JP)

(72) Inventors: Masashi HAMAYA, Bunkyo-ku, TOKYO (JP); Joaquin ROYO MIQUEL, Bunkyo-ku, TOKYO (JP); Cristian Camilo BELTRAN-HERNANDEZ, Bunkyo-ku, TOKYO (JP); Kazutoshi TANAKA, Bunkyo-ku, TOKYO (JP)

(21) Appl. No.: 19/487,903

(22) PCT Filed: Jun. 5, 2024
(86) PCT No.: PCT/JP2024/020552

§ 371 Date: Nov. 25, 2025

(30) Foreign Application Priority Data
Jun. 23, 2023 (JP) 2023-103349

(51) Int. Cl. B25J 9/16; B25J 13/08

(52) U.S. Cl. CPC B25J 9/1653; B25J 9/163; B25J 9/1674; B25J 13/084; G05B 2219/39001; G05B 2219/40625

(57) ABSTRACT

A control device (1) according to an aspect of the present invention is configured to hold an anomaly detection model (AD) and control an operation of a robot device (R1) including a fingertip portion (R12) provided with a tactile sensor (RS). The control device (1) acquires target observation data (125) from the tactile sensor (RS), detects occurrence of an event in accordance with whether a tendency of a tactile sense indicated by the acquired target observation data (125) is abnormal using the anomaly detection model (AD), and switches an operation of the robot device (R1) according to the detection of the occurrence of the event.

### TECHNICAL FIELD

The present invention relates to a control device, a control program, and a control method.

### BACKGROUND ART

For example, a robot device is used in a situation in which a task involving contact such as delivery of a component, assembly, and manipulation of a target object is performed. The robot device is, for example, an industrial robot such as a manipulator. Patent Literature 1 proposes a technology for causing a robot device to execute a high-speed operation involving contact. Non-Patent Literature 1 proposes a learning method for component insertion using a flexible robot device. The flexible robot device can safely execute an operation involving contact. Therefore, it is preferable to use the flexible robot device to perform a task involving contact.

### CITATION LIST

### Patent Literature

Patent Literature 1: JP 2021-142632 A

### Non-Patent Literature

Non-Patent Literature 1: Hamaya, M., Lee, R., Tanaka, K., von Drigalski, F., Nakashima, C., Shibata, Y., & Ijiri, Y. (2020 May), “Learning robotic assembly tasks with lower dimensional systems by leveraging physical softness and environmental constraints”, [online], in 2020 IEEE International Conference on Robotics and Automation (ICRA) (pp. 7747-7753), [Retrieved Jun. 21, 2023], Internet <URL: https://www.researchgate.net/publication/341833371_Learning_Robotic_Ass embly_Tasks_with_Lower_Dimensional_Systems_by_Leveraging_Physical Softness_and_Environmental_Constraints>

### SUMMARY OF THE INVENTION

### Problems to be Solved by the Invention

The inventors of the present invention have found that a control method of the related art has the following problems. That is, regardless of the presence or absence of flexibility, a variation in a condition for executing a task adversely affects the accuracy of appropriately completing the task. In particular, a variation in a positional relationship such as a target position (for example, a placement location of a target object) and an orientation/position of a component held by an end effector leads to a decrease in the execution accuracy of a task.

As an example, a situation is assumed in which a hole is searched for in a state in which a peg is held by an end effector (for example, a gripper), and a robot device is caused to perform a task of inserting the peg into the hole found by the search. In this case, an orientation (position and angle) of the peg to be held varies, and thus, task conditions such as a positional relationship between the peg and the hole, and a force acting on the end effector during the execution of the task may vary. This may result in problems such as a delay in detecting the discovery of a hole, causing the peg to pass by a position of the hole, and making it impossible to insert the peg into the hole.

On the other hand, by fixing the target object using a dedicated jig, it is possible to suppress variation in the positional relationship. However, in this method, when task conditions such as task content and a target object are changed, a new jig is prepared (that is, a jig is prepared for each condition), and thus a cost is increased. Even though a jig is used, tolerances may be present for a task target object such as a component. Therefore, there is a limit to the suppression of decrease in the execution accuracy of the task due to the variation in the positional relationship by using this method.

The present invention has been made in view of such circumstances in an aspect, and an object thereof is to provide a control technology for improving the execution accuracy of a task involving contact while allowing a variation in a positional relationship of a target object.

### Means for Solving the Problem

To achieve the above-described object, the present invention employs the following configurations. Configurations of the following invention can be combined appropriately.

A control device according to an aspect of the present invention is a control device for a robot device including a fingertip portion provided with a tactile sensor, and includes a storage unit that stores an anomaly detection model, and a control unit. The control unit is configured to execute: acquiring target observation data from the tactile sensor; detecting occurrence of an event in accordance with whether a tendency of a tactile sense indicated by the acquired target observation data is abnormal, using the anomaly detection model; and switching an operation of the robot device in accordance with detection of the occurrence of the event.

When the robot device is caused to perform a task involving contact, the tendency of the force acting on the fingertip portion may change instantaneously and greatly at a point in time of switching of the operation (task) of the robot device. For example, in an example of a case of the peg, while the distal end of the peg is brought into contact with a target surface and a hole provided in the target surface is searched for, the fingertip portion of the robot device is moved in a substantially horizontal direction with respect to the target surface. On the other hand, after the hole is found, the fingertip portion of the robot device is moved in a direction substantially perpendicular to the target surface to insert the peg into the hole. That is, in one example, a timing at which the hole is found is a timing at which the operation of the robot device is switched. Before the hole is found, while the hole is searched for while the peg is brought into contact with the target surface, a reaction force from the target surface acts on the fingertip portion with the same tendency although a magnitude of an acting force varies depending on an orientation of the peg. On the other hand, at a timing when the hole is found (that is, the distal end of the peg engages with the hole), the reaction force from the target surface disappears, and the distal end of the peg collides with an edge or side surface of the hole. Accordingly, the tendency of the force acting on the fingertip portion changes instantaneously and greatly at a point in time of switching of the operation of the robot device. As shown in examples to be described later, the inventors of the present invention have found that, by detecting a large change in the tendency of the force (tactile sense) acting on the fingertip portion as an anomaly using an anomaly detection scheme (anomaly detection model), a switching timing of the operation can be accurately specified even when there is a variation in the positional relationship of the target object. When a timing of switching the operation can be accurately specified, the operation corresponding to each task can be executed at an appropriate timing, and thus improvement in the execution accuracy of the task can be expected. Therefore, according to the configuration, it is possible to improve the execution accuracy of the task involving contact while allowing a variation in a positional relationship of the target object.

The control device according to the aspect need not necessarily independently control the operation of the robot device as long as the control device is involved in the switching of the operation of the robot device. Information processing for controlling the operation of the robot device may be executed by any computer. In one example, the control of the operation of the robot device may be executed by another computer different from the control device according to the configuration. In this case, the switching of the operation of the robot device may include instructing the other computer to switch the operation. In another example, the control of the operation of the robot device may be executed by the control device according to the aspect. That is, the control device according to the aspect may be configured to independently control the operation of the robot device. In this case, the control device may directly control the operation of the robot device or may indirectly control the operation of the robot device via a lower-level controller.

In the control device according to the aspect, the storage unit may further store an identifier for identifying a situation of the robot device from a plurality of situations. The storage unit may store a plurality of the anomaly detection models, and each of the plurality of anomaly detection models may be prepared corresponding to one of the plurality of situations. The control unit may be configured to further execute: identifying a current situation of the robot device using the identifier; and selecting an anomaly detection model to be used from among the plurality of anomaly detection models in accordance with a result of identifying the current situation The detecting of the occurrence of the event may include detecting the occurrence of the event in accordance with whether the tendency of the tactile sense indicated by the acquired target observation data is abnormal, using the selected anomaly detection model. According to this configuration, even when three or more tasks are defined before a final target state, it is possible to improve the execution accuracy of the task involving contact while allowing the variation in the positional relationship of the target object.

In the control device according to the aspect, the identifier may be configured to identify the situation from observation data of the tactile sensor. The identifying of the current situation may include identifying the current situation from the acquired target observation data using the identifier. According to this configuration, it is not necessary to prepare an additional configuration for identifying a situation, and thus it is possible to suppress an increase in cost.

In the control device according to the aspect, the switching of the operation of the robot device may include controlling an operation of the robot device so that a first task is performed until before the occurrence of the event is detected; and controlling the operation of the robot device so that a second task is performed after detecting the occurrence of the event. According to this configuration, it is possible to improve the execution accuracy of the task involving contact while allowing the variation in the positional relationship of the target object in a situation in which the operation of the robot device is controlled independently.

In the control device according to the aspect, the first task and the second task may be defined so that an event in which a tendency of a tactile sense observed by the tactile sensor changes occurs during switching from the first task to the second task. According to this configuration, by clearly defining the first task and the second task in accordance with the event in which the tendency of the tactile sense changes, it is possible to expect highly accurate event detection using the anomaly detection model. This makes it possible to appropriately switch a task that is performed from the first task to the second task, and as a result, to expect an improvement in task execution accuracy.

In the control device according to the aspect, the anomaly detection model may be configured to detect occurrence of the event as an anomaly from observation data of the tactile sensor obtained while the first task is being executed. In one example of the present invention, the anomaly detection model may be configured to collect abnormal data and detect an anomaly from the abnormal data. However, it is difficult to acquire the abnormal data compared to the normal data, and data collection tends to be costly. On the other hand, according to the configuration, the anomaly detection model is configured to detect an anomaly from observation data of the tactile sensor obtained while the first task is being executed, that is, the normal data. This makes it possible to reduce the cost of generating the anomaly detection model.

In the control device according to the above aspect, the storage unit may further store a first control model and a second control model. The first control model may be given according to the first task, and the second control model may be given according to the second task. The controlling of the operation of the robot device so that the first task is executed may include controlling the operation of the robot device using the first control model. The controlling of the operation of the robot device so that the second task is executed may include controlling the operation of the robot using the second control model. According to this configuration, it is possible to improve the execution accuracy of the task involving contact while allowing the variation in the positional relationship of the target object in a situation in which the control model is used for the operation control of the robot device.

In the control device according to the aspect, the storage unit may further store an identifier for identifying a situation of the robot device from a plurality of situations. The first task and the second task may be defined for each of the situations. The storage unit may store a plurality of the anomaly detection models, a plurality of first control models, and a plurality of second control models. Each of the plurality of anomaly detection models, each of the plurality of first control models, and each of the plurality of second control models may be prepared to correspond to each of the plurality of situations. The control unit may be configured to further execute: identifying a current situation of the robot device using the identifier; and selecting an anomaly detection model, a first control model, and a second control model to be used from among the plurality of anomaly detection models, the plurality of first control models, and the plurality of second control models in accordance with a result of identifying the current situation. The detecting of the occurrence of the event may include detecting the occurrence of the event in accordance with whether the tendency of the tactile sense indicated by the acquired target observation data is abnormal, using the selected anomaly detection model. The using of the first control model may include using the selected first control model The using of the second control model may include using the selected second control model. According to this configuration, even when three or more tasks are defined before the final target state, it is possible to improve the execution accuracy of the task involving contact while allowing the variation in the positional relationship of the target object.

In the control device according to the aspect, the identifier may be configured to identify the situation from observation data of the tactile sensor The identifying of the current situation may include identifying the current situation from the acquired target observation data using the identifier. According to this configuration, it is not necessary to prepare an additional configuration for identifying a situation, and thus it is possible to suppress an increase in cost.

In the control device according to the aspect, the first control model may be implemented as a machine learning model. The first task is a task before an event of the task switching, and the second task is a task after the event. A degree of freedom of the action when the second task is performed is often lower than that of the first task by an amount of execution of the action until the event. On the other hand, a degree of freedom of the action when the first task is performed is often higher than that of the second task. When the degree of freedom is high, it takes time and effort to make a rule, and thus it is difficult to generate a control model using a rule-based model. On the other hand, according to this configuration, by adopting the machine learning model as the first control model, even when the degree of freedom of the first task is high, it is possible to expect easy generation of the first control model capable of appropriately performing the first task.

In the control device according to the aspect, the first control model may be generated by model-based reinforcement learning using a cross-entropy method (CEM). The machine learning model implemented as the first control model may include a function equation that defines a distribution representing an action space. According to this configuration, as shown in the example to be described later, the first control model can be appropriately obtained by adopting the model-based reinforcement learning using the CEM as a machine learning scheme.

In the control device according to the aspect, the second control model may be implemented as a rule-based model. As described above, a degree of freedom of the action when the second task is performed is often lower than that of the first task According to the configuration, it is possible to expect easy generation of the second control model capable of appropriately performing the second task while suppressing the generation cost of the model by adopting the rule-based model as the second control model.

In the control device according to the aspect, the fingertip portion may include an end effector. The first task may be to search for a hole provided in a target surface of a second target object while bringing a first target object held by the end effector into contact with the target surface. The second task may be to insert the first target object into the hole that has been searched for. According to this configuration, for example, in a situation in which a task of inserting the target object into the hole, such as inserting the peg into the hole or inserting the sample into a hole of a centrifuge, is performed, it is possible to improve the execution accuracy of the task involving contact while allowing the variation in the positional relationship of the target object.

In the control device according to the aspect, the robot device may have flexibility. According to the configuration, when the task is performed, it is possible to release the load generated due to the contact through the flexibility of the robot device. In particular, when the first target object is inserted into the hole of the second target object, when the first task and the second task are performed, it is possible to release a load acting between the first target object and the second target object due to the flexibility of the robot device. This makes it possible to perform the task while allowing the generation of a relatively large load. That is, the task can be easily performed. On the other hand, since the robot device has flexibility, a variation in the positional relationship easily occurs, which easily causes a decrease in the execution accuracy of the task. As shown in the example to be described later, even when such a robot device having flexibility is adopted, the configuration for detecting the point in time of switching of the task (event occurrence) using the anomaly detection model is adopted to make it possible to expect improvement in execution accuracy of the task.

In the control device according to the aspect, the switching of the operation of the robot device may include outputting a command for switching the operation of the robot device to the robot device or an external computer configured to control the operation of the robot device. According to this configuration, it is possible to improve the execution accuracy of the task involving contact while allowing the variation in the positional relationship of the target object in a situation in which the operation of the robot device is instructed (control of the operation of the robot device is executed by another computer).

The present invention is not limited to the control device. As another aspect of the control device according to each of the aspects, an aspect of the present invention may be an information processing method that realizes all or a part of the configurations, may be a program, or may be a storage medium that stores such a program and is readable by a machine such as a computer. Here, the term “computer-readable storage medium” refers to a medium that stores information such as programs through electrical, magnetic, optical, mechanical, or chemical actions.

For example, a control program according to an aspect of the present invention may be a program for causing a computer to execute: acquiring target observation data from a tactile sensor provided in a fingertip portion of a robot device; detecting occurrence of an event in accordance with whether a tendency of a tactile sense indicated by the acquired target observation data is abnormal, using an anomaly detection model; and switching an operation of the robot device in accordance with the detection of the occurrence of the event.

Further, for example, a control method according to an aspect of the present invention may be an information processing method including: acquiring, by a computer, target observation data from a tactile sensor provided in a fingertip portion of a robot device; detecting, by the computer, occurrence of an event in accordance with whether a tendency of a tactile sense indicated by the acquired target observation data is abnormal, using an anomaly detection model; and switching, by the computer, an operation of the robot device in accordance with the detection of the occurrence of the event.

### Effect of the Invention

According to the present invention, it is possible to improve the execution accuracy of the task involving contact while allowing the variation in the positional relationship of the target object.

### BRIEF DESCRIPTION OF THE DRAWINGS

FIG. 1 schematically illustrates a situation in which the present invention is applied.

FIG. 2A schematically illustrates an example of a configuration of a robot device according to an embodiment.

FIG. 2B schematically illustrates an example of a configuration of a fingertip portion of the robot device according to the embodiment.

FIG. 3 schematically illustrates an example of a process of selecting a model according to the embodiment.

FIG. 4 schematically illustrates an example of a switching process according to the embodiment.

FIG. 5 schematically illustrates an example of a relationship between tasks to be performed by the robot device according to the embodiment.

FIG. 6A schematically illustrates an example of a first task to be performed by the robot device according to the embodiment.

FIG. 6B schematically illustrates an example of an event that occurs between the first task and a second task according to the embodiment.

FIG. 6C schematically illustrates an example of the second task to be performed by the robot device according to the embodiment.

FIG. 7A schematically illustrates another example of the first task to be performed by the robot device according to the embodiment.

FIG. 7B schematically illustrates another example of an event that occurs between the first task and a second task according to the embodiment.

FIG. 7C schematically illustrates another example of the second task to be performed by the robot device according to the embodiment.

FIG. 8 schematically illustrates a hardware configuration of a control device according to an embodiment.

FIG. 9 schematically illustrates an example of a software configuration of the control device according to the embodiment.

FIG. 10 is a flowchart illustrating an example of a processing procedure of the control device according to an embodiment.

FIG. 11 schematically illustrates an example of a method of calculating an orientation of a fingertip of the robot device according to the embodiment.

FIG. 12 schematically illustrates an example of a calculation process of a first control model according to an embodiment.

FIG. 13 schematically illustrates an example of a control process of a second control model according to an embodiment.

FIG. 14 schematically illustrates an example of a switching process according to another embodiment.

FIG. 15 is a flowchart illustrating an example of a processing procedure of a control device according to another embodiment.

FIG. 16 shows experimental results of examples and comparative examples.

### MODE FOR CARRYING OUT THE INVENTION

Hereinafter, an embodiment according to an aspect of the present invention (hereinafter referred to also as “the present embodiment”) will be described below with reference to the drawings. However, the present embodiment to be described below is merely an example of the invention in all respects. Various improvements or modifications may be made without departing from the scope of the present disclosure. A specific configuration according to the embodiment may be adopted appropriately in implementing the invention. Although the data in the present embodiment is described in natural language, it is more specifically specified in a pseudo-language, command, parameter, machine language, and the like, which can be recognized by a computer.

### § 1 Application Example

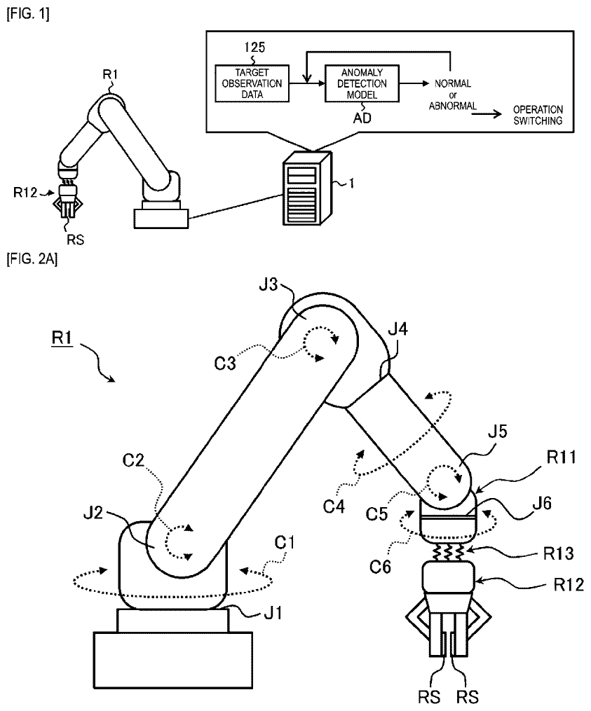

FIG. 1 schematically illustrates a situation in which the present invention is applied. The control device 1 according to the present embodiment is one or more computers configured to execute processing related to control of an operation of the robot device R1. The robot device R1 includes a fingertip portion R12 provided with a tactile sensor RS. The control device 1 is configured to be able to use the anomaly detection model AD.

In the present embodiment, the control device 1 acquires a target observation data 125 from the tactile sensor RS. In one example, the target observation data 125 is observation data (measurement value) obtained in real time from the tactile sensor RS when the robot device R1 is controlled. Subsequently, the control device 1 detects the occurrence of an event in accordance with whether the tendency of the tactile sense indicated by the acquired target observation data 125 is abnormal, using the anomaly detection model AD. The control device 1 switches the operation of the robot device R1 in accordance with the detection of the occurrence of the event.

When the robot device is caused to perform a task involving contact, the tendency of the force acting on the fingertip portion may change instantaneously and greatly at a point in time of switching of the task of the robot device. As shown in examples to be described later, the inventors of the present invention have found that, by detecting a large change in the tendency of the force (tactile sense) acting on the fingertip portion as an anomaly using an anomaly detection scheme (anomaly detection model), a switching timing of the operation can be accurately specified even when there is a variation in the positional relationship of the target object. When a timing of switching the operation can be accurately specified, the operation corresponding to each task can be executed at an appropriate timing, and thus improvement in the execution accuracy of the task can be expected. Therefore, according to the present embodiment, it is possible to improve the execution accuracy of the task involving contact while allowing the variation in the positional relationship of the target object in the robot device R1.

### (Robot Device)

The robot device R1 can execute a task with a component including the fingertip portion R12, and a configuration of the robot device R1 may be determined appropriately depending on an embodiment.

In one example, the robot device R1 may be configured to be flexible. The term “flexible” means that the fingertip portion is configured to be displaceable in accordance with an applied force when the force is applied to the fingertip portion (for example, when the force is applied to the target object gripped by the gripper). In one example, the fingertip portion R12 may include an end effector, and the robot device R1 may include an arm for driving the end effector. In this case, the robot device R1 may be configured to be flexible by using a physically elastic member at a position of at least one of the middle of the end effector, between the end effector and the arm, and the middle of the arm. The elastic member may be selected appropriately depending on an embodiment. In one example, the elastic member may be a spring, a fluid (air, liquid, or the like) pressure actuator, an elastomer (such as rubber), a shape memory array, or a combination thereof.

According to an example of the present embodiment, when the task is performed, it is possible to release the load generated due to the contact through the flexibility of the robot device R1. This makes it possible to perform the task while allowing the generation of a relatively large load. That is, it is possible to facilitate the execution of the task. On the other hand, since the robot device has flexibility, a variation in the positional relationship easily occurs, which easily causes a decrease in the execution accuracy of the task. In the present embodiment, even in a situation in which the robot device R1 having flexibility is adopted, the configuration for detecting the point in time of switching of the task (event occurrence) using the anomaly detection model AD is adopted to make it possible to expect improvement in execution accuracy of the task. That is, detecting the point in time of switching the task using the anomaly detection model AD can suitably achieve the operation and effect when the robot device having such flexibility is adopted. The configuration of the robot device R1 is not limited to such an example. In another example, the robot device R1 may be configured to be inflexible (that is, rigid).

The fingertip portion R12 of the robot device R1 may be configured in any way. In one example, the fingertip portion R12 of the robot device R1 may include an end effector. The end effector may be, for example, a gripper, a robot hand, or the like. The type of the gripper may be freely selected, and may be, for example, a gripping type, a suction type, or the like. The gripper may be, for example, an electric gripper (motor driven), an air gripper, a suction gripper (for example, vacuum type), a magnet gripper, or the like. The fingertip portion R12 may include a jig, but the jig is preferably omitted from the viewpoint of cost. In another example, the end effector may be omitted. For example, the fingertip portion R12 of the robot device R1 may be implemented as a distal end of the arm.

A type of tactile sensor RS is not particularly limited as long as the tactile sensor can measure a load acting on the fingertip portion R12, and may be selected appropriately depending on an embodiment. The tactile sensor RS may be, for example, a tactile sensor or the like. A configuration of the observation data obtained by the tactile sensor RS is not particularly limited, and may be appropriately determined according to a type of the tactile sensor RS. The tactile sensor RS is disposed on the fingertip portion R12 of the robot device R1. The disposition of the tactile sensor RS may be freely determined as long as force that can act on the fingertip portion R12 can be detected. As an example, when the fingertip portion R12 is includes a gripping type gripper, the tactile sensor RS may be disposed at a place at which the tactile sensor RS can come into contact with the target object gripped by the gripper, such as side surfaces of a gripping portion, that is, side surfaces of the gripper facing each other (that is, surfaces gripping the target object). The robot device R1 may further include a sensor other than the tactile sensor RS. In one example, the robot device R1 may further include any sensor such as a force sensor or an encoder.

### Example of Robot Device

FIG. 2A is a diagram schematically illustrating an example of the configuration of the robot device R1 according to the present embodiment. FIG. 2B schematically illustrates an example of a configuration of the fingertip portion R12 of the robot device R1 according to the present embodiment. In an example of the present embodiment, the robot device R1 is a six axis vertical articulated robot. In particular, the robot device R1 includes an arm R11, a flexible portion R13, and the fingertip portion R12. The arm R11 includes six joints J1 to J6, and thus has six degrees of freedom. The joints J1 to J6 connect links to each other to be rotatable in respective directions (C1 to C6) using a built-in motor.

A force sensor RF is provided on a distal end R11A of the arm R11, and the flexible portion R13 is connected to the distal end R11A via the force sensor RF. The fingertip portion R12 (gripping type gripper) is connected to the distal end R11A of the arm R11 via the flexible portion R13, and is configured to move according to driving of the arm R11.

A type of force sensor RF may be freely selected. The force sensor RF may be, for example, a force/torque sensor. The force sensor RF is disposed between the distal end R11A of the arm R11 and the flexible portion R13, thereby observing a load acting on the flexible portion R13. The load acting on the flexible portion R13 changes according to an inclination of the fingertip portion R12. Therefore, the inclination of the fingertip portion R12 can be estimated based on observation data (measurement value) of the force sensor RF.

In the example of FIGS. 2A and 2B, the flexible portion R13 includes three springs. However, a configuration of the flexible portion R13 is not limited to such an example. The number of springs may be freely selected. A configuration of the flexible portion R13 is not particularly limited as long as the flexible portion R13 is a mechanism that exhibits flexibility by generating a restoring force against a change in position. The flexible portion R13 may be configured by a hydraulic actuator, an elastomer, a shape memory array, or a combination thereof, in addition to or in place of springs.

The fingertip portion R12 includes a pair of gripping portions R12A to form a gripping type gripper. Tactile sensors RS in a pair are disposed on side surfaces of the gripping portions R12A in the pair facing each other. Thus, the tactile sensor RS is disposed to be able to contact the target object gripped by the gripper, and observes the load acting on the fingertip portion R12 from the target object.

The configuration of the robot device R1 is not limited to the examples of FIGS. 2A and 2B, and the components can be omitted, replaced, and added appropriately depending on an embodiment. In another example, the robot device R1 may be a horizontal articulated robot (scalar robot). In another example, the robot device R1 may be a parallel link robot. The number of joints is not limited to six, and may be five or less, or may be seven or more. The number of joints may be freely selected. The robot device R1 may further include a switching mechanism for switching between a state in which the fingertip portion R12 is flexible with respect to the arm R11 and a state in which the fingertip portion R12 is fixed to the arm R11. In the example of FIGS. 2A and 2B, the flexible portion R13 is disposed between the distal end R11A of the arm R11 and the fingertip portion R12. However, the disposition of the flexible portion R13 is not limited to such an example. In another example, the flexible portion R13 may be provided in the middle of the fingertip portion R12 (for example, in the middle of a support portion that supports the gripping portion or between the gripping portion and the support portion) or in the middle of the arm R11 (for example, at least one of the joints J1 to J6 or in the middle of a link that constitutes the arm). The robot device R1 may include a plurality of flexible portions R13. The force sensor RF may be omitted. At least some of the joints J1 to J6 may be configured to be capable of measuring angles by including an encoder. One of the pair of tactile sensors RS may be omitted. The disposition of the tactile sensor RS may be freely changed.

### (Anomaly Detection Model)

In the present embodiment, in the anomaly detection model AD, whether the tendency of the tactile sense is abnormal is determined in accordance with whether there is a difference in the observation data by the anomaly detection scheme. That is, the presence of the difference that can be detected by an anomaly detection scheme corresponds to a change in the tendency of the tactile sense (the tendency of the tactile sense is determined to be abnormal). The control device 1 regards a timing at which the anomaly is detected by the anomaly detection model AD as a time point of occurrence of the event, and switches the operation of the robot device R1 at this timing. That is, the anomaly detection model AD is configured to determine that the tendency of the tactile sense before the operation is switched (before the event occurs) is normal and determine that the tendency of the tactile sense at the timing of switching the operation (at the point in time of the event occurrence) is abnormal.

The event is the event in which the tendency of the tactile sense changes. The event may be referred to as a switching event. The event in which the tendency of the tactile sense changes may be appropriately determined according to a task to be performed by the robot device R1. In one example, the event may be that the fingertip portion R12 or the target object held by the fingertip portion R12 comes into contact with any object from a free state, or that the fingertip portion R12 is moved while the fingertip portion R12 or the target object held by the fingertip portion R12 comes in contact with any object, causing a change in a contact state (for example, engaging with the hole in a state of being in contact with the target surface). In the present embodiment, a task to be executed by the robot device R1 before switching the operation (before the occurrence of the event) may be referred to as a first task, and a task to be executed by the robot device R1 after switching the operation (after the occurrence of the event) may be referred to as a second task.

The anomaly detection model AD that has acquired the ability of the determination may be generated appropriately from at least one of normal data and abnormal data. The normal data is observation data obtained by the tactile sensor RS before the occurrence of the event (that is, at the time of performing the first task). The abnormal data is observation data obtained by the tactile sensor RS at a point in time when the event occurs (that is, a timing of transition from the first task to the second task). The configuration of the anomaly detection model AD is not particularly limited, and may be selected appropriately depending on an embodiment.

The anomaly detection model AD may be able to acquire the capability of the determination, and a configuration thereof may be appropriately selected depending on an embodiment. The anomaly detection model AD may be implemented as any calculation model such as a machine learning model or a calculation model including an observation data group. The machine learning model is configured to have one or more calculation parameters that are adjustable by machine learning. The one or more calculation parameters are used for calculation of a target inference (anomaly detection in the anomaly detection model AD). Machine learning is to adjust (optimize) the values of calculation parameters using training samples. The machine learning model may be implemented as, for example, a neural network, a regression model, a decision tree model, a support vector machine, any other function equation (calculation model), or the like. A machine learning method may be selected appropriately according to the machine learning model to be adopted (for example, error backpropagation). When the machine learning model is adopted, the anomaly detection model AD may be appropriately subjected to tuning such as transfer learning, relearning, additional learning, or the like. The anomaly detection model AD may be trained offline or online.

In one example, the anomaly detection model AD may be implemented as a neural network such as an auto-encoder. A structure of the neural network may be determined appropriately depending on an embodiment, and may be specified by, for example, the number of layers from an input layer to an output layer, a type of each layer, the number of nodes (neurons) included in each layer, a connection relationship between the nodes of each layer. In one example, the neural network may have a recursive structure. Further, the neural network may include, for example, any layer such as a fully connected layer, a convolutional layer, a pooling layer, a deconvolutional layer, an unpooling layer, a normalization layer, a dropout layer, and a long short-term memory (LSTM). When the neural network is adopted for the anomaly detection model AD, a weight of connection between respective nodes included in the anomaly detection model AD and a threshold value of each node are examples of the calculation parameter.

As long as the anomaly in the tendency of the tactile sense can be detected, a form of input and output of the anomaly detection model AD need not be particularly limited and may be appropriately selected depending on an embodiment. Input data of the anomaly detection model AD may further include other data than the target observation data 125 as long as the input data includes the target observation data 125 (measurement value) obtained from the tactile sensor RS at the time of inference. In one example, raw data obtained by the tactile sensor RS may be given to the anomaly detection model AD as the target observation data 125. In another example, any preprocessing may be applied to the target observation data 125 before the target observation data 125 is provided to the anomaly detection model AD. The preprocessing may include any analysis processing such as derivation of the optical flow, Helmholtz-Hodge decomposition, and Fourier transform. When anomaly detection is inferred, the target observation data 125 to which the preprocessing has been applied may be given to the anomaly detection model AD. An output of the anomaly detection model AD (a calculation result of the anomaly detection model AD) may directly or indirectly indicate a degree (inference result) of whether the tendency of the tactile sense is abnormal. Indirectly indicating the degree includes obtaining a result of inferring whether the tendency of the tactile sense is abnormal by executing any information processing for the output obtained from the anomaly detection model AD. When the anomaly detection model AD is implemented as an auto-encoder, indirectly indicating the degree may include deriving the degree of whether the tendency of the tactile sense is abnormal according to a reconstruction error of the auto-encoder.

In one example, the anomaly detection model AD may be configured to detect the occurrence of the event as an anomaly based on the observation data of the tactile sensor RS obtained while the first task is being executed. That is, the anomaly detection model AD may include a one-class identifier using the normal data. In this case, the anomaly detection model AD may be configured to determine the tactile sense during the execution of the first task as normal and determine the tactile sense at a time point of achievement of a goal of the first task (that is, the time point of occurrence of the event) as abnormal, using the observation data (a plurality of training samples and the observation data group) of the tactile sensor RS obtained during the execution of the first task. A timing at which the anomaly in the tendency of the tactile sense is detected is the time point of occurrence of the event, and is a timing of transition from the first task to the second task. The robot device R1 and the tactile sensor RS that obtain the observation data (the training samples and the observation data group) may be the same as or different from the robot device R1 and the tactile sensor RS that are control targets.

As an example of this case, the anomaly detection model AD may be implemented as an auto-encoder (for example, a variational auto-encoder). The auto-encoder is implemented as an encoder and a decoder. The encoder is configured to encode input data into a feature quantity. The decoder is configured to decode the input data from the feature quantity. Machine learning of the auto-encoder is performed using observation data obtained by the tactile sensor RS while the first task is being performed as a training sample and a teacher signal. That is, the auto-encoder is trained so that an output obtained from the decoder by inputting a training sample to the encoder and executing calculation processing of the encoder and the decoder is suitable for the training sample. This allows the trained auto-encoder to acquire the ability to recover input data in a range of training samples. That is, the closer the input data is in a range of the training sample, the smaller the reconstruction error between the input data and the output data becomes, and the farther the input data is from the training sample, the larger the reconstruction error becomes. Therefore, in this example, it is possible to determine whether the tendency of the tactile sense is abnormal based on a magnitude of the reconstruction error calculated from the target observation data 125 using the auto-encoder. For example, an anomaly can be detected when the reconstruction error exceeds a threshold value.

A method of configuring the anomaly detection model AD using the one-class identifier is not limited to such an example. In another example, the anomaly detection model AD may include a principal component vector (eigenvector) obtained by performing principal component analysis on the observation data (normal data) of the tactile sensor RS obtained while the first task is being executed. In this case, the control device 1 can calculate the feature quantity by projecting the target observation data 125 onto a subspace using the principal component vector constituting the anomaly detection model AD. As the target observation data 125 is more distant from the distribution of the normal data, a feature quantity of the target observation data 125 is a value more distant from the feature quantity of the normal data. The control device 1 may determine whether the tendency of the tactile sense is abnormal by comparing the feature quantity obtained from the normal data with the feature quantity obtained from the target observation data 125 in the subspace. Further, similarly to the example of the auto-encoder, the control device 1 may restore data from the feature quantity of the subspace, and determine whether the tendency of the tactile sense is abnormal according to the magnitude of the reconstruction error between the obtained restored data and the target observation data 125. In another example, the anomaly detection model AD may include another one-class identifier such as a one-class support vector machine generated by machine learning using a plurality of training samples obtained from the normal data. In another example, the anomaly detection model AD may include the observation data group of the tactile sensor RS while the first task is being executed. In this case, the anomaly detection model AD may determine whether the tendency of the tactile sense is abnormal according to comparison (for example, outlier determination) between the observation data group and the target observation data 125 using a statistical scheme.

In another example of the present embodiment, the abnormal data may be collected, and the anomaly detection model AD may be generated using the collected abnormal data. The anomaly detection model AD may be generated using both the normal data and the abnormal data. However, it is more difficult to acquire the abnormal data compared to normal data, and it often takes a cost to collect data. On the other hand, in the example of the present embodiment, the anomaly detection model AD is generated from the observation data of the tactile sensor RS obtained while the first task is being executed, that is, the normal data. This makes it possible to expect a reduction in cost related to generation of the anomaly detection model AD.

### (Switching Situation)

In a simple example of the present embodiment, there may be one situation for switching the operation of the robot device R1. However, a task sequence of the robot device R1 need not be limited to such an example. In another example, there may be the plurality of situations. Accordingly, the control device 1 may hold the plurality of anomaly detection models AD, and each of the plurality of anomaly detection models AD may be prepared corresponding to each of the plurality of situations. That is, the anomaly detection model AD may be given for each situation. The control device 1 may select the anomaly detection model AD to be used from among the plurality of anomaly detection models AD by using any method.

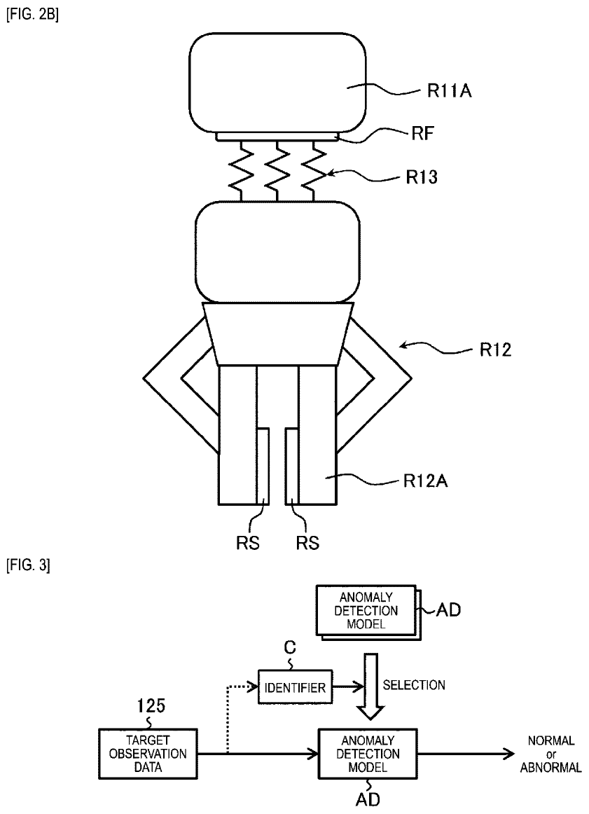

FIG. 3 schematically illustrates an example of a process related to selection of the anomaly detection model AD according to the present embodiment. In the example of FIG. 3, the control device 1 further holds an identifier C for identifying the situation of the robot device R1 from the plurality of situations. The control device 1 may identify the current situation of the robot device R1 using the identifier C. The control device 1 may select the anomaly detection model AD to be used from among the plurality of anomaly detection models AD in accordance with a result of identifying the current situation. Typically, the control device 1 may select the anomaly detection model AD prepared corresponding to the identified situation from among the plurality of anomaly detection models AD. Accordingly, the detection of the occurrence of the event may include detecting the occurrence of the event in accordance with whether the tendency of the tactile sense indicated by the acquired target observation data 125 is abnormal using the selected anomaly detection model AD. According to this configuration, even when three or more tasks are defined before the final target state, it is possible to improve the execution accuracy of the task involving contact while allowing the variation in the positional relationship of the target object in the robot device R1.

A configuration of the identifier C is not particularly limited as long as the identifier C can identify a situation, and may be appropriately selected depending on an embodiment. The identifier C may be implemented as any calculation model such as a machine learning model or a rule-based model. The situation may be defined appropriately according to an event to be detected. The situation may correspond to any environment before the occurrence of the event (that is, when the first task is performed). An explanatory variable for identifying the situation (that is, the information given to the identifier C) may be selected appropriately depending on an embodiment.

In one example, the identifier C may be configured to identify a situation from the observation data of the tactile sensor RS. Identifying the current situation may include identifying the current situation from the acquired target observation data 125 using the identifier C. According to an example of the present embodiment, it is not necessary to prepare an additional configuration for identifying a situation, and thus it is possible to suppress an increase in cost. In another example, one or more other sensors other than the tactile sensor RS may be used together with the tactile sensor RS or instead of the tactile sensor RS for identification of the situation. The other sensor may be, for example, an encoder, a force sensor, or an image sensor. The identifier C may be configured to identify a situation from observation data obtained by one or more other sensors.

A timing at which the identifier C identifies the situation may be determined appropriately depending on an embodiment. In one example, the control device 1 may execute a process of identifying the situation a plurality of times before detecting the event, such as every control cycle. However, in an example of the present embodiment, the same anomaly detection model AD is used until an event is detected. Therefore, in another example, the control device 1 may omit the process of identifying the situation until the event is detected by the selected anomaly detection model AD after the process of identifying the situation is executed once.

A method of selecting the anomaly detection model AD is not limited to the method using the identifier C. When the order of tasks is defined in advance, an event to be detected (an anomaly detection model to be used) can be identified from a task to be actually executed (the first task). Therefore, in another example, the control device 1 may select the anomaly detection model AD to be used according to the task to be actually executed without using the identifier C. For example, a use rule of the anomaly detection model AD (for example, the order) may be defined in advance, and the control device 1 may select the anomaly detection model AD to be used, according to the use rule.

### (Switching of Operation Control)

The control device 1 according to the present embodiment need not necessarily independently control the operation of the robot device R1 as long as the control device is involved in the switching of the operation of the robot device R1. The information process for controlling the operation of the robot device R1 may be executed by any computer.

In one example, a process of controlling the operation of the robot device R1 may be executed by the control device 1. Switching the operation of the robot device R1 may include a step of controlling the operation of the robot device R1, so that the first task is performed until before the occurrence of the event is detected, and a step of controlling the operation of the robot device R1, so that the second task is performed, after detecting the occurrence of the event. In this case, the control device 1 may directly control the operation of the robot device R1 or may indirectly control the operation of the robot device R1 via a lower-level controller. When each task is performed, the control device 1 may control the operation of the robot device R1 by using any method. According to an example of the present embodiment, it is possible to improve the execution accuracy of the task involving contact while allowing the variation in the positional relationship of the target object in a situation in which the operation of the robot device R1 is controlled independently.

In another example, the process of controlling the operation of the robot device R1 may be executed by one or more other computers other than the control device 1. The other computer may be a computer included in the robot device R1 or an external computer. Switching the operation of the robot device R1 may include outputting a command for switching the operation of the robot device R1 to the robot device R1 or to one or more external computers configured to control the operation of the robot device R1. A plurality of computers may be involved in performing a task. The computer controlling the performance of the first task and the computer controlling the performance of the second task may be the same or may be different. According to an example of the present embodiment, it is possible to improve the execution accuracy of the task involving contact while allowing the variation in the positional relationship of the target object in a situation in which the operation of the robot device R1 is instructed (control of the operation of the robot device R1 is executed by another computer).

When the robot device R1 includes a single operation element, switching the operation of the robot device R1 may be switching the control scheme of the single operation element. Including the single operation element may be, for example, a series of components performing a task being a single component, such as including a combination of an arm and an end effector. An entity that controls the operation of the robot device R1 may be the same or may be different before and after the operation is switched. The controlling entity is, for example, one or more computers. In one example, the robot device R1 in FIGS. 2A and 2B may be construed as including a single operation element (the arm R11 and the fingertip portion R12).

On the other hand, when the robot device R1 includes a plurality of operation elements, in one example, switching the operation of the robot device R1 may be switching a control scheme of at least one of the plurality of operation elements. As described above, an entity that controls the operation of the robot device R1 may be the same or different before and after the operation is switched. In another example, switching the operation of the robot device R1 may be switching an operation entity from the first operation element to the second operation element among the plurality of operation elements. When the operation entity is switched, the entity that controls the first operation element and the entity that controls the second operation element may be the same or may be different. As described above, the controlling entity is, for example, one or more computers.

### (Task)

The task to be executed by the robot device R1 may be defined appropriately depending on an embodiment. In one example, the first task and the second task may be defined so that an event in which the tendency of the tactile sense observed by the tactile sensor RS changes occurs during the switching from the first task to the second task. In this case, the first task is defined as a task before the occurrence of the event, and the second task is defined as a task after the occurrence of the event. A timing of switching from the first task to the second task may be a time point at which the goal of the first task is achieved. According to an example of the present embodiment, by clearly defining the first task and the second task in accordance with the event in which the tendency of the tactile sense changes, it is possible to expect highly accurate event detection using the anomaly detection model AD. This makes it possible to appropriately switch a task that is performed from the first task to the second task, and as a result, to expect an improvement in task execution accuracy. When each task is performed, the operation of the robot device R1 may be controlled by using any method.

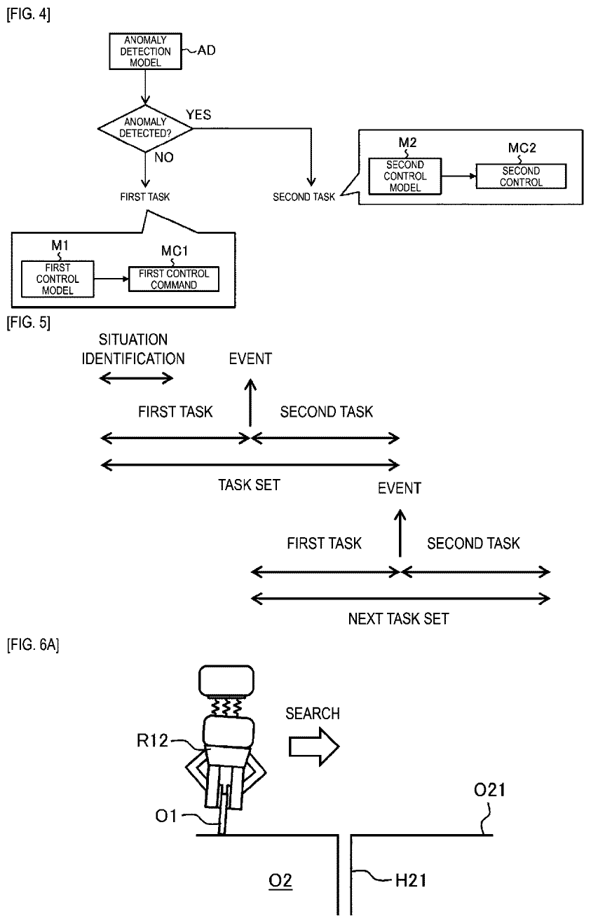

FIG. 4 schematically illustrates an example of a switching and control scheme in the control device 1 according to the present embodiment. In the example of FIG. 4, the control device 1 further holds a first control model M1 and a second control model M2. The first control model M1 is given in accordance with the first task. The first control model M1 may be configured appropriately to derive a control command according to the first task. The second control model M2 is given in accordance with the second task. The second control model M2 may be configured appropriately to derive the control command according to the second task.

Controlling the operation of the robot device R1 so that the first task is performed may include controlling the operation of the robot device R1 using the first control model M1. In one example, the control device 1 may derive a first control command MC1 using the first control model M1 until before the anomaly in the tendency of the tactile sense is detected by the anomaly detection model AD, and control the operation of the robot device R1 according to the derived first control command MC1. Similarly, controlling the operation of the robot device R1 so that the second task is performed may include controlling the operation of the robot device R1 using the second control model M2. In one example, after detecting the anomaly of the tactile sense by the anomaly detection model AD, the control device 1 may derive a second control command MC2 by using the second control model M2, and control the operation of the robot device R1 according to the derived second control command MC2. According to an example of the present embodiment, it is possible to expect improvement in execution accuracy of the task involving contact while allowing the variation in the positional relationship of the target object in a situation in which a control model is used for operation control of the robot device R1.

The case in which the plurality of situations exist may be applied to a case in which this control model is used. In one example, the control device 1 may further hold the identifier C for identifying the situation of the robot device R1 from the plurality of situations. The first task and the second task may be defined for each situation. The control device 1 may hold a plurality of anomaly detection models AD, a plurality of first control models M1, and a plurality of second control models M2. Each anomaly detection model AD, each first control model M1, and each second control model M2 may be prepared corresponding to each situation. That is, the anomaly detection model AD, the first control model M1, and the second control model M2 may be given for each situation. The control device 1 may identify the current situation of the robot device R1 using the identifier C. The control device 1 may select the anomaly detection model AD, the first control model M1, and the second control model M2 to be used from among the plurality of anomaly detection models AD, the plurality of first control models M1, and the plurality of second control models M2 according to the result of identifying the current situation. Typically, the control device 1 may select the anomaly detection model AD, the first control model M1, and the second control model M2 prepared corresponding to the identified situation among the plurality of anomaly detection models AD, the plurality of first control models M1, and the plurality of second control models M2. Accordingly, the detection of the occurrence of the event may include detecting the occurrence of the event in accordance with whether the tendency of the tactile sense indicated by the acquired target observation data 125 is abnormal using the selected anomaly detection model AD. Using the first control model M1 may include using the selected first control model M1. Using the second control model M2 may include using the selected second control model M2. According to an example of the present embodiment, even when three or more tasks are defined before the final target state, it is possible to improve the execution accuracy of the task involving contact while allowing the variation in the positional relationship of the target object in the robot device R1.

Further, in an example of the present embodiment, the identifier C may be configured to identify a situation from the observation data of the tactile sensor RS. Accordingly, identifying the current situation may include identifying the current situation from the acquired target observation data 125 using the identifier C. According to an example of the present embodiment, it is possible to suppress an increase in cost in a situation in which the operation of the robot device R1 is controlled independently.

Similarly to the above, in another example of the present embodiment, one or more other sensors other than the tactile sensor RS may be used together with the tactile sensor RS or instead of the tactile sensor RS for the identification of the situation. The method of selecting the anomaly detection model AD, the first control model M1, and the second control model M2 to be used is not limited to the method using the identifier C. In another example, the control device 1 may select the anomaly detection model AD, the first control model M1, and the second control model M2 to be used, according to the task to be actually executed without using the identifier C. For example, the control device 1 may select the anomaly detection model AD, the first control model M1, and the second control model M2 to be used, according to the use rule.

A combination of the first task and the second task may be defined as a task set. In one example, a plurality of task sets may be set appropriately from a start state of the task to the final target state. The task set may be defined according to a situation. Each task set may include a combination of the first task and the second task. Each situation may correspond to an environment in which it is determined that the first task of a corresponding task set is performed. The anomaly detection model AD, the first control model M1, and the second control model M2 may be prepared for each task set.

FIG. 5 schematically illustrates an example of a relationship between tasks to be executed by the robot device R1 according to the present embodiment. As illustrated in FIG. 5, when a certain task set is defined in series with a next task set, the second task of the certain task set may be the first task of the next task set. A certain task set is also referred to as the first task set, and the next task set is also referred to as a second task set. In at least some of the plurality of task sets, the first task set and the second task set may be defined such that the relationship between the second task of the first task set and the first task of the second task set is held.

Accordingly, the anomaly detection model AD, the first control model M1, and the second control model M2 may be prepared for each situation (task set), and at least partially, the first task defined corresponding to a certain situation may be the second task defined corresponding to a situation next to the certain situation. The second control model M2 used to perform the second task of the first task set may be the first control model M1 used to perform the first task of the second task set. That is, the first task and the second task may partially overlap. The first control model M1 and the second control model M2 may partially overlap.

In an example of the present embodiment, after the current situation is identified by the identifier C, the control device 1 may detect the occurrence of the event (anomaly in the tendency of the tactile sense) using the selected anomaly detection model AD. Until the occurrence of the event is detected, the control device 1 may control the operation of the robot device R1 so that the first task is performed using the selected first control model M1. On the other hand, after the occurrence of the event is detected, the control device 1 may control the operation of the robot device R1 to perform the second task using the selected second control model M2. When the identified current situation is the first task set satisfying the relationship, performing the second task using the selected second control model M2 may be performing the first task using the first control model M1 prepared corresponding to the next situation. That is, selecting the second control model M2 according to the result of identifying the current situation may include selecting the first control model M1 prepared corresponding to the next situation of the identified current situation.

### (Control Model)

A configuration of each control model (M1 or M2) need not be particularly limited as long as the control command can be directly or indirectly derived from the state of the robot device R1, and may be determined appropriately depending on an embodiment. A state of the robot device R1 may include a current situation observed in real time by a sensor. In one example, the state of the robot device R1 may further include a past state.

Any sensor may be used to observe the state of the robot device R1. In at least one of the first control model M1 and the second control model M2, a sensor for obtaining observation data used for deriving of the control command may include the tactile sensor RS provided in the fingertip portion R12. In addition, the sensor may include an encoder, a force sensor, an image sensor (camera), and the like.

The control command may correspond to an action to be executed by the robot device R1. A format of the control command is not particularly limited, and may be determined appropriately depending on an embodiment. In one example, the control command may be configured appropriately to designate a control amount of the robot device R1 such as a movement amount of the fingertip portion R12 or a driving amount of the joints.

Each control model (M1 or M2) may be implemented as at least one of a machine learning model and a rule-based model. The rule-based model is configured to match a given input against a rule and derive a control command in accordance with a result of the matching (that is, in accordance with an applicable rule). The rules may be set heuristically. Accordingly, the rule-based model may be referred to as a heuristic model. As described above, the machine learning model is configured to have one or more calculation parameters that can be adjusted by machine learning. The one or more calculation parameters are used for calculation of a target inference (derivation of the control command in the control model). Machine learning is to adjust (optimize) the values of calculation parameters using training samples. The machine learning model may be implemented as, for example, a neural network, a regression model, a decision tree model, a support vector machine, any other function equation (calculation model), or the like. A machine learning method may be selected appropriately according to the machine learning model to be adopted (for example, error backpropagation). When the machine learning model is adopted, the control model may be appropriately subjected to tuning such as transfer learning, relearning, additional learning, or the like. The control model may be trained offline or online.

When a neural network is used for at least one of the control models (M1 and M2), a structure of the neural network may be determined appropriately depending on an embodiment, and may be specified by, for example, the number of layers from the input layer to the output layer, the type of each layer, the number of nodes included in each layer, and a connection relationship between the nodes of each layer. In one example, the neural network may have a recursive structure. Further, the neural network may include, for example, any layer such as a fully connected layer, a convolutional layer, a pooling layer, a deconvolutional layer, an unpooling layer, a normalization layer, a dropout layer, and an LSTM. The neural network may include any type of model, such as a diffusion model or a generative model.

A type of machine learning may be freely selected from unsupervised learning (including adversarial learning), supervised learning, semi-supervised learning, reinforcement learning, and the like. When the reinforcement learning is adopted, either model-based reinforcement learning or model-free reinforcement learning may be employed as the type of machine learning. The model-based reinforcement learning is a scheme using an environment model for predicting a state (next state) at time t+1 from a state and an action at time t. The model-free reinforcement learning is a scheme that does not use such an environment model. The environment model may be implemented as at least one of a machine learning model and a rule-based model. When the environment model is implemented as a machine learning model, the environment model may be trained together with a control model (machine learning model). The environment model may be trained offline or online.

In one example, the first control model M1 may be implemented as a machine learning model. The first task is a task before the event of the task switching, and the second task is a task after the event. A degree of freedom of the action when the second task is performed is often lower than that of the first task by an amount of execution of the action until the event. On the other hand, a degree of freedom of the action when the first task is performed is often higher than that of the second task. When the degree of freedom is high, it takes time and effort to make a rule, and thus it is difficult to generate a control model using a rule-based model. On the other hand, in an example of the present embodiment, even when the first task has a high degree of flexibility, it is possible to expect easy generation of the first control model M1 that can appropriately execute the first task by adopting a machine learning model for the first control model M1.

When the machine learning model is adopted for the first control model M1, in one example, the first control model M1 may be generated by the model-based reinforcement learning using the cross-entropy method (CEM). The machine learning model implemented as the first control model M1 may include a function equation that defines a distribution representing an action space. A specific example will be described later (FIG. 12). According to an example of the present embodiment, as shown in an example to be described later, the first control model M1 can be appropriately obtained by adopting the model-based reinforcement learning using the CEM as a machine learning scheme. The first control model M1 need not be limited to such an example. In another example, the first control model M1 may be generated by another type of model-based reinforcement learning such as a policy gradient type. In another example, the first control model M1 may be generated by the model-free reinforcement learning. In another example, the first control model M1 may be generated by a machine learning other than the reinforcement learning. In another example, the first control model M1 may be generated by a rule-based model.

In one example, the second control model M2 may be implemented as the rule-based model. As described above, the degree of freedom of the action when the second task is performed is often lower than that of the first task. According to an example of the present embodiment, it is possible to expect easy generation of the second control model M2 capable of appropriately performing the second task while suppressing the generation cost of the model by adopting the rule-based model for the second control model M2. A heuristic model may be used for the second control model M2. A specific example will be described later (FIG. 13). The second control model M2 need not be limited to such an example. The second control model M2 may be implemented as a machine learning model.

As long as the control command can be derived, a form of input and output of each control model (M1 or M2) need not be particularly limited, and may be selected appropriately depending on an embodiment. Any information on the state of the robot device R1 may be given to Each control model (M1 or M2). In one example, observation data obtained by observing the state of the robot device R1 through a sensor may be directly given to the control model. In another example, any preprocessing (which may include processing such as analysis and inference) may be applied to the observation data before the observation data is provided to the control model. The observation data (which may include an analysis result, an inference result, and the like) to which the preprocessing has been applied may be given to the control model. Information other than the information on the state of the robot device R1 may be given to at least one of the control models M1 and M2. The information used for inference (derivation of the control command) may be the same or at least partially different between the first control model M1 and the second control model M2. Further, an output of the control model may directly or indirectly indicate the control command. The indirectly indicating includes deriving a control command by executing any information processing for an output obtained from the control model.

### Specific Example of Task

In the present embodiment, the first task is defined by a category of manipulations in which the tendency of the tactile sense observed by the tactile sensor RS is the same or similar (a range that can be evaluated as normal by the anomaly detection scheme). The first task and the second task are defined so that a change in the tendency of the tactile sense that can be detected by the anomaly detection scheme (anomaly detection model AD) occurs therebetween. Otherwise, the first task and the second task may be freely defined. The first task and the second task may be set appropriately according to the task to be performed by the robot device R1. The task to be performed by the robot device R1 may be selected appropriately depending on an embodiment.

### (A) Insertion of Target Object

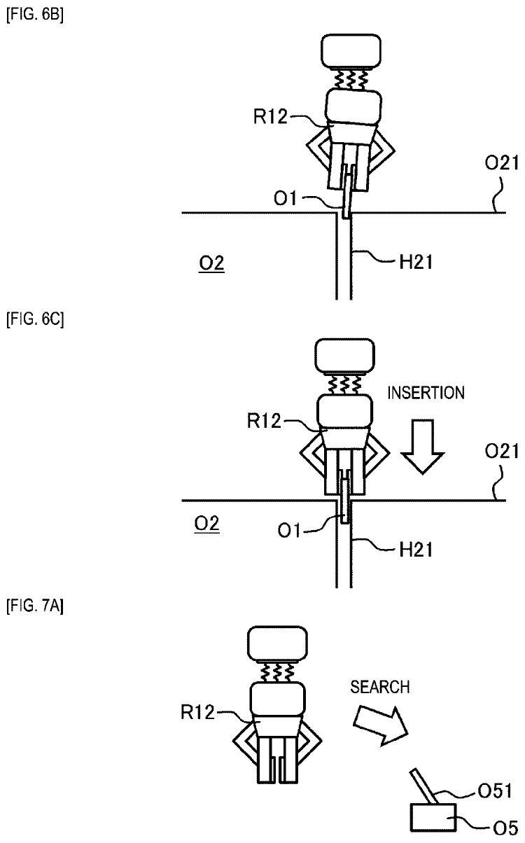

FIGS. 6A and 6C schematically illustrate examples of the first task and the second task to be performed by the robot device R1 according to the present embodiment. FIG. 6B schematically illustrates an example of an event occurring between the first task and the second task. In examples of FIGS. 6A to 6C, it is assumed that a first target object O1 is inserted into a hole H21 provided in a target surface O21 of a second target object O2, such as the peg being inserted into a predetermined hole or a sample being inserted into a centrifuge. The first target object O1 is, for example, a peg or a sample. The second target object O2 is, for example, an insertion destination of the peg, or a centrifuge.

In this case, the fingertip portion R12 may include the end effector. In the example of FIGS. 6A to 6C, the fingertip portion R12 includes the gripping type gripper. The first task may be to search for the hole H21 provided in the target surface O21 while bringing the first target object O1 (for example, a distal end of the first target object O1) held by an end effector (the fingertip portion R12) into contact with the target surface O21 of the second target object O2 (FIG. 6A). Between the first task and the second task (that is, at the time point when the goal of the first task is achieved), the distal end of the first target object O1 engages with the hole H21, causing change in the tendency of the tactile sense. The anomaly detection model AD may be configured appropriately to be able to detect this change as an anomaly. That is, the event may be that the first target object O1 engages with the hole H21 (FIG. 6B). The second task may insert the first target object O1 into the hole H21 that has been searched for (FIG. 6C). According to an example of the present embodiment, in a situation in which a task of inserting the first target object O1 into the hole H21 of the second target object O2 is performed, it is possible to improve the execution accuracy of the task involving contact while allowing variation in the positional relationship of the target objects.

### (B) Manipulation of Target Object

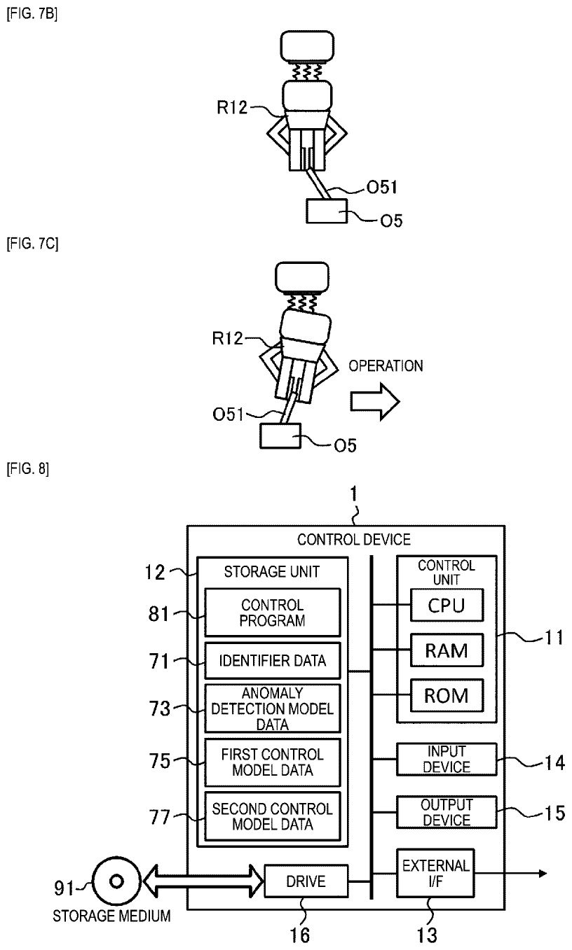

FIGS. 7A and 7C schematically illustrate another example of the first task and the second task to be performed by the robot device R1 according to the present embodiment. FIG. 7B schematically illustrates another example of an event occurring between the first task and the second task. In the example of FIGS. 7A to 7C, it is assumed that a manipulation tool O5 is manipulated by the robot device R1. The manipulation tool O5 is, for example, a switch, or a button.

In this case, the fingertip portion R12 may include the end effector. In the example of FIGS. 7A to 7C, the fingertip portion R12 includes the gripping type gripper. The first task may search for the manipulation tool O5 by the fingertip portion R12 (FIG. 7A). Searching for the manipulation tool O5 may include bringing the manipulation portion O51 (a switch, a button, or the like) into contact with or holding the fingertip portion R12. The event may be that the manipulation tool O5 comes into contact with the fingertip portion R12 (FIG. 7B). The anomaly detection model AD may be configured appropriately to be able to detect a change in the tendency of the tactile sense due to the contact as an anomaly. The second task may manipulate the manipulation tool O5 (manipulation portion O51) that has been searched for (FIG. 7C). Manipulating the manipulation tool O5 may be, for example, pushing the manipulation portion O51, changing an orientation of the manipulation portion O51, or the like. According to an example of the present embodiment, it is possible to improve the execution accuracy of the task involving contact while allowing the variation in the positional relationship of the target object in a situation in which a task of manipulating the manipulation tool O5 is performed.

### (C) Others

The task to be performed by the robot device R1 need not be limited to the examples of (A) and (B), and may be determined appropriately depending on an embodiment.

In another example, the first task may search for a search object and bring the fingertip portion R12 or the target object held on the fingertip portion R12 in a free state (non-contact state) into contact with the search object. The event may be that the fingertip portion R12 or the target object held on the fingertip portion R12 comes into contact with the search object. The second task may manipulate the fingertip portion R12 or the target object held by the fingertip portion R12 on the search object. For example, the first task may bring a target object (for example, a peg or a sample) into contact with a target surface including a hole. The second task may search for the hole on the target surface while bringing the target object into contact with the target surface, similarly to the first task in (A). In this case, the target surface is an example of the search object. (B) may be construed as an example of this case (the manipulation tool O5 is an example of the search object).

In still another example, the first task may be to search for the target object using the fingertip portion R12 in a free state. The searching may include holding the target object. Holding the target object may be, for example, passing at least a part of the fingertip portion (such as fingers of a robot hand) through a handle of a tool (such as a mug cup), or supporting a package (a book, a cardboard box, or the like). The event may be that the fingertip portion R12 comes into contact with the target object. The second task may transport the target object. Transporting the target object may be, for example, carrying a mug cup in front of a target person, carrying a book to a predetermined bookshelf location, or carrying a cardboard box to a predetermined storage location.

### (Model Configuration)

When the machine learning model is used for at least two or more models among the identifier C, the anomaly detection model AD, the first control model M1, and the second control model M2, the two or more models may be configured separately from each other or may be configured at least partially integrally. When the output is configured to be switchable by a conditional machine learning model, a state in which output corresponding to a first condition is performed and a state in which output corresponding to a second condition is performed may be counted as different machine learning models. That is, two or more models may be implemented as one conditional machine learning model.

### § 2 Example of Configuration

### [Hardware Configuration]

FIG. 8 is a diagram schematically illustrating a hardware configuration of the control device 1 according to the present embodiment. In the example of FIG. 8, the control device 1 according to the present embodiment is a computer in which a control unit 11, a storage unit 12, an external interface 13, an input device 14, an output device 15, and a drive 16 are electrically connected.

The control unit 11 includes a central processing unit (CPU), a random access memory (RAM), a read only memory (ROM) and the like, and is configured to execute information processing based on programs and various types of data. The control unit 11 (CPU) is an example of a processor resource. The storage unit 12 is implemented as, for example, a hard disk drive or a solid state drive. The storage unit 12, the RAM, and the ROM are examples of memory resources. In the present embodiment, the storage unit 12 stores various types of information such as a control program 81, identifier data 71, anomaly detection model data 73, first control model data 75, and second control model data 77.

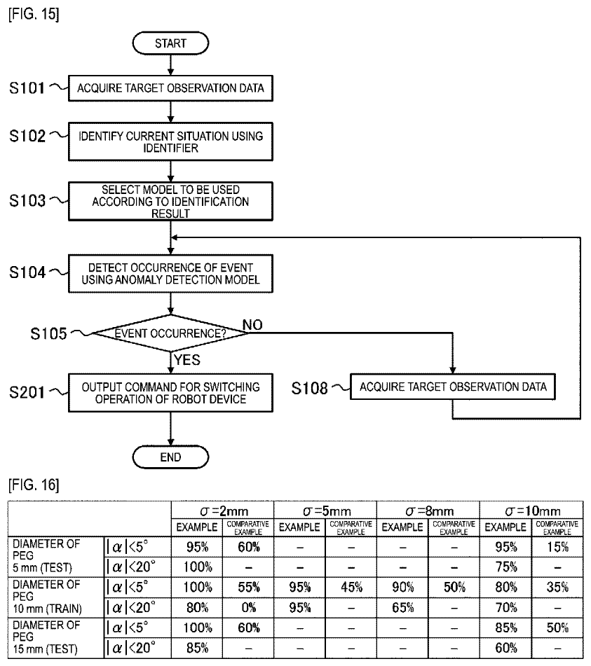

The control program 81 is a program for causing the control device 1 to execute information processing (FIGS. 10 and 15 to be described later) involved in the control of the operation of the robot device R1. The control program 81 includes a series of instructions for the information processing. The identifier data 71 indicates information related to the identifier C. The anomaly detection model data 73 indicates information related to the anomaly detection model AD. The first control model data 75 indicates information related to the first control model M1. The second control model data 77 indicates information related to the second control model M2. Hereinafter, for ease of description, the identifier C, the anomaly detection model AD, the first control model M1, and the second control model M2 are also simply referred to as “model”.

As long as each model can be used at the time of inference, a configuration of information on each model may be determined appropriately depending on an embodiment. In one example, when a machine learning model is adopted, the information on the model may include information indicating the value of the calculation parameter adjusted by the machine learning. In some cases, the information on the model may further include information indicating a configuration of the machine learning model (for example, a structure of a neural network). When the rule-based model is adopted, the information on the model may include information indicating a rule. Storing the model in the storage unit may be holding data related to the model in at least one of the storage unit 12, the RAM, and the ROM. Storing the model in the storage unit may include temporarily holding the data related to the model. At least one of the identifier data 71, the anomaly detection model data 73, the first control model data 75, and the second control model data 77 may be incorporated in the control program 81.

The external interface 13 may be, for example, a universal serial bus (USB) port, a communication port, or a dedicated port, and is configured to be connected to an external device in a wired or wireless manner. The type and number of the external interfaces 13 may be freely selected. When the external interface 13 includes a communication port, a communication standard of the communication port may be freely selected. In the present embodiment, the control device 1 may be connected to the robot device R1 or an external computer via the external interface 13.

The input device 14 is a device for performing input, such as a mouse, a keyboard, and a manipulator. The output device 15 is, for example, a device for performing output, such as a display or a speaker. The operator can manipulate the control device 1 by using the input device 14 and the output device 15. The input device 14 and the output device 15 may be connected via the external interface 13. The input device 14 and the output device 15 may be integrally implemented as, for example, a touch panel display.

The drive 16 is a device for reading various types of information such as a program stored in a storage medium 91. At least one of the control program 81, the identifier data 71, the anomaly detection model data 73, the first control model data 75, and the second control model data 77 may be stored in the storage medium 91 instead of the storage unit 12 or together with the storage unit 12. The storage medium 91 is configured to accumulate various types of information (such as a stored program) through an electrical, magnetic, optical, mechanical, or chemical action so that a machine such as a computer can read the information. The control device 1 may acquire at least one of the control program 81, the identifier data 71, the anomaly detection model data 73, the first control model data 75, and the second control model data 77 from the storage medium 91. The storage medium 91 may be a disk-type storage medium such as a CD or a DVD, or may be a storage medium other than a disk-type storage medium, such as a semiconductor memory (for example, a flash memory). A type of the drive 16 may be appropriately selected according to a type of the storage medium 91. The drive 16 may be connected via the external interface 13.

With respect to a specific hardware configuration of the control device 1, components can be omitted, replaced, and added appropriately depending on an embodiment. For example, the control unit 11 may include a plurality of hardware processors. The hardware processor may be implemented as a microprocessor, a field-programmable gate array (FPGA), a digital signal processor (DSP), a graphics processing unit (GPU), or the like. The storage unit 12 may be implemented as a RAM and a ROM included in the control unit 11. At least one of the external interface 13, the input device 14, the output device 15, and the drive 16 may be omitted. The control device 1 may be implemented as a plurality of computers. In this case, hardware configurations of the respective computers may or may not match. Further, the control device 1 may be not only an information processing device designed specifically for a provided service, but also a general-purpose server device, a general-purpose personal computer (PC), a tablet PC, or a terminal device.

### [Software Configuration]

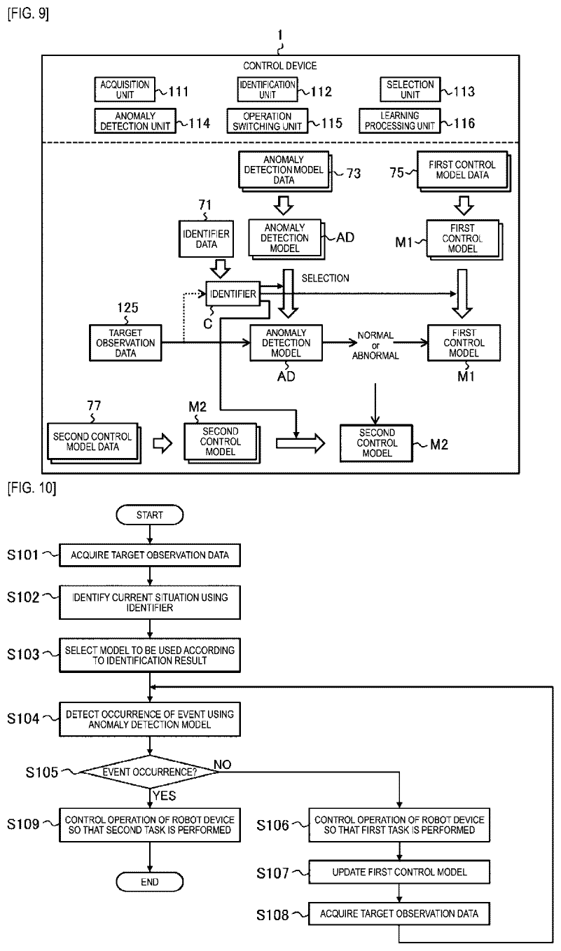

FIG. 9 schematically illustrates an example of a software configuration of the control device 1 according to the present embodiment. The control unit 11 of the control device 1 loads the control program 81 stored in the storage unit 12 into the RAM, and executes instructions included in the control program 81 using the CPU. Thus, the control device 1 operates as a computer including an acquisition unit 111, an identification unit 112, a selection unit 113, an anomaly detection unit 114, an operation switching unit 115, and a learning processing unit 116 as software modules. That is, in the present embodiment, each software module of the control device 1 is realized by the control unit 11 (CPU).

The acquisition unit 111 is configured to acquire the target observation data 125 from the tactile sensor RS. The identification unit 112 includes the identifier C by holding the identifier data 71. The identification unit 112 is configured to identify a current situation of the robot device R1 using the identifier C. In an example of the present embodiment, the identifier C may be configured to identify a situation from the observation data of the tactile sensor RS. The identification unit 112 may be configured to identify the current situation from the acquired target observation data 125 using the identifier C. The selection unit 113 is configured to select the anomaly detection model AD, the first control model M1, and the second control model M2 to be used from among the plurality of anomaly detection models AD, the plurality of first control models M1, and the plurality of second control models M2 in accordance with the result of identifying the current situation.

The anomaly detection unit 114 includes the anomaly detection model AD by holding anomaly detection model data 73. The anomaly detection unit 114 is configured to detect the occurrence of an event in accordance with whether the tendency of the tactile sense indicated by the acquired target observation data 125 is abnormal, using the anomaly detection model AD. In an example of the present embodiment, the anomaly detection unit 114 may include the plurality of anomaly detection models AD. The anomaly detection unit 114 may be configured to detect the occurrence of an event in accordance with whether the tendency of the tactile sense indicated by the acquired target observation data 125 is abnormal, using the anomaly detection model AD selected from among the plurality of anomaly detection models AD.

The operation switching unit 115 is configured to switch the operation of the robot device R1 in response to detection of the occurrence of the event. In an example of the present embodiment, the operation switching unit 115 may be configured to control the operation of the robot device R1 so that the first task is performed until before the occurrence of the event is detected, and control the operation of the robot device R1 so that the second task is performed after detecting the occurrence of the event. When the control device 1 controls the operation of the robot device R1, the operation switching unit 115 may also be referred to as an operation control unit. In an example of the present embodiment, the operation switching unit 115 may include the first control model M1 and the second control model M2 by holding the first control model data 75 and the second control model data 77. The operation switching unit 115 may be configured to control the operation of the robot device R1 so that the first task is performed using the first control model M1. The operation switching unit 115 may be configured to control the operation of the robot device R1, so that the second task is performed, using the second control model M2. Further, in an example of the present embodiment, the operation switching unit 115 may include a plurality of first control models M1 the plurality of second control models M2. The operation switching unit 115 may be configured to control the operation of the robot device R1, so that the first task is performed, using the first control model M1 selected from among the plurality of first control models M1. The operation switching unit 115 may be configured to control the operation of the robot device R1, so that the second task is performed, using the second control model M2 selected from among the plurality of second control models M2.

The learning processing unit 116 is configured to perform machine learning of a model implemented as a machine learning model. Performing the machine learning may include updating the model by tuning such as relearning, additional learning, or the like using the operation result. In an example of the present embodiment, the second control model M2 is implemented as the rule-based model, whereas the first control model M1 may be implemented as a machine learning model. Accordingly, the learning processing unit 116 may be configured to update the first control model M1 using the result of controlling the operation of the robot device R1 so that the first task is performed.

In the present embodiment, an example in which each software module of the control device 1 is realized by a general-purpose CPU is described. However, some or all of the software modules may be implemented by one or more dedicated processors or chip sets. Each of the modules may be implemented as a hardware module. Regarding a software configuration of the control device 1, modules may be omitted, replaced, and added appropriately depending on an embodiment.

### § 3 Example of Operation

FIG. 10 is a flowchart showing an example of a processing procedure of the control device 1 according to the present embodiment. The following processing procedure is an example of a control method executed by a computer. However, the following processing procedure of the control device 1 is merely an example, and each step may be changed as much as possible. Further, in the following processing procedure, steps can be omitted, replaced, and added appropriately depending on an embodiment.

### (Step S101)

In step S101, the control unit 11 operates as the acquisition unit 111 and acquires the target observation data 125 from the tactile sensor RS. In one example, the control unit 11 may acquire the target observation data 125 directly from the tactile sensor RS. In another example, the control unit 11 may indirectly acquire the target observation data 125 from the tactile sensor RS via another computer. When the control unit 11 acquires the target observation data 125, the control unit 11 advances the processing to the next step S102.

### (Step S102)

In step S102, the control unit 11 operates as the identification unit 112, and identifies the current situation of the robot device R1 using the identifier C. The control unit 11 gives any information that can be involved in the situation of the robot device R1 to the identifier C, and executes calculation processing of the identifier C, thereby obtaining the result of identifying the current situation. In one example, the control unit 11 may obtain the result of identifying the current situation by providing the target observation data 125 to the identifier C and executing calculation processing of the identifier C. When the identified result is obtained, the control unit 11 advances the processing to the next step S103.

### (Step S103)

In step S103, the control unit 11 operates as the selection unit 113, and selects the anomaly detection model AD, the first control model M1, and the second control model M2 to be used from among the plurality of anomaly detection models AD, the plurality of first control models M1, and the plurality of second control models M2 according to the result of identifying the current situation. When the model is selected, the control unit 11 advances the processing to the next step S104.

### (Step S104)

In step S104, the control unit 11 operates as the anomaly detection unit 114, and detects the occurrence of an event in accordance with whether the tendency of the tactile sense indicated by the acquired target observation data 125 is abnormal, using the anomaly detection model AD. In one example, the control unit 11 may provide the target observation data 125 to the anomaly detection model AD selected in step S103, and execute calculation processing of the anomaly detection model AD. As a result of this calculation processing, the control unit 11 may acquire a result of determining whether an event has occurred (that is, whether the tendency of the tactile sense is abnormal). Further, in one example, the control unit 11 may execute any preprocessing on the target observation data 125 before the target observation data 125 is given to the anomaly detection model AD. The control unit 11 may provide the target observation data 125 to which the preprocessing has been applied to the anomaly detection model AD.

As a specific example, the anomaly detection model AD may be implemented as an auto-encoder such as a variational auto-encoder. The control unit 11 may input the target observation data 125 (input data) to which the preprocessing has been applied to the auto-encoder, and execute calculation processing in a forward direction of the auto-encoder. As a result of this calculation processing, the control unit 11 may acquire the restored data (output data) from the auto-encoder. The control unit 11 may calculate a difference between the target observation data 125 and the restored data as the reconstruction error, and compare the calculated reconstruction error with a threshold value. The threshold value may be appropriately set. When the reconstruction error exceeds the threshold value, the control unit 11 may determine that the tendency of the tactile sense is abnormal. On the other hand, when the reconstruction error is smaller than the threshold value, the control unit 11 may determine that the tendency of the tactile sense is normal. When the reconstruction error is equal to the threshold value, the control unit 11 may determine that the tendency is normal or abnormal. When a detection result (determination result) is obtained, the control unit 11 advances the processing to the next step S105.

### (Step S105)

In step S105, the control unit 11 operates as the operation switching unit 115, and determines a transition destination of the processing according to a result of the detection in step S104. When the occurrence of an event is not detected (that is, the tendency of the tactile sense is determined to be normal), the control unit 11 advances the processing to the next step S106. On the other hand, when the occurrence of the event is detected (that is, when the tendency of the tactile sense is determine to be abnormal), the control unit 11 advances the processing to the next step S109.

### (Step S106 to Step S108)

In step S106, the control unit 11 operates as the operation switching unit 115 and controls the operation of the robot device R1 so that the first task is performed. In one example, the control unit 11 may control the operation of the robot device R1 so that the first task is performed using the first control model M1 selected in step S103. The first control model M1 is given in accordance with the first task. The control unit 11 may give any information on the state of the robot device R1 to the first control model M1 to execute calculation processing of the first control model M1. As a result of this calculation processing, the control unit 11 may acquire a result of deriving the first control command MC1 from the first control model M1. The control unit 11 may control the operation of the robot device R1 according to the derived first control command MC1. The control unit 11 may acquire any information to be given to the first control model M1 at any timing before executing the processing of step S106. Any information may include the target observation data 125. In this case, the processing of acquiring any information may include the processing of step S101 described above. When the operation of the robot device R1 is controlled, the control unit 11 advances the processing to the next step S107.

In step S107, the control unit 11 operates as the learning processing unit 116 and executes tuning of the first control model M1 using an operation result of step S106. Accordingly, the control unit 11 updates the first control model M1. The control unit 11 may update the first control model data 75 by reflecting a result of the tuning in the first control model data 75. When the update of the first control model M1 is completed, the control unit 11 advances the processing to the next step S108.

In step S108, the control unit 11 operates as the acquisition unit 111 and acquires the target observation data 125 from the tactile sensor RS. Step S108 is the same as step S101 described above. When the control unit 11 acquires the target observation data 125, the control unit 11 returns the processing to step S104 and executes the processing again from step S104. In the processing of step S104, the control unit 11 repeatedly executes the processing of steps S106 to S108 until the occurrence of an event is detected (until the tendency of the tactile sense is determine to be abnormal). Accordingly, in the example of FIG. 10, the control unit 11 controls the operation of the robot device R1 using the first control model M1 until the execution of the first task is completed, and updates the first control model M1 using a result of the control. In a process of repeating the processing, in the processing of step S106, the information on the state of the robot device R1 to be given to the first control model M1 may be acquired appropriately at any timing. When the information on the state of the robot device R1 includes the target observation data 125, processing of acquiring the information may include processing of step S108.

### (Step S109)

In step S109, the control unit 11 operates as the operation switching unit 115 and controls the operation of the robot device R1 so that the second task is performed. In one example, the control unit 11 may control the operation of the robot device R1 so that the second task is performed, using the second control model M2 selected by step S103. The second control model M2 is given in accordance with the second task. The control unit 11 may give any information on the state of the robot device R1 to the second control model M2 and execute calculation processing of the second control model M2. As a result of this calculation processing, the control unit 11 may acquire a result of deriving the second control command MC2 from the second control model M2. The control unit 11 may control the operation of the robot device R1 according to the derived second control command MC2. The control unit 11 may acquire any information to be given to the second control model M2 at any timing before the processing of step S109 is executed. Any information may include the target observation data 125. In this case, the processing of acquiring any information may include the processing of step S101 or S108. The control unit 11 may repeatedly execute the processing of step S109 until the execution of the second task is completed. In this operation example, a processing of step S105, step S106, and step S109 is an example of processing of switching the operation of the robot device R1.

When the operation control of the robot device R1 is completed, the control unit 11 ends the processing procedure of the control device 1 according to the present operation example. The control unit 11 may repeatedly execute a series of information processing from step S101 to S109. A timing of repetition may be determined appropriately depending on an embodiment. In one example, a plurality of task sets may be defined. In this case, the control unit 11 may switch to the next task set in accordance with the switching to the second task in step S105 above, and may repeatedly execute the processing from step S101. Accordingly, the control unit 11 may continue the operation control of the robot device R1 until the execution of each task of all the task sets is completed.

### Specific Example

As a specific example of the control process, a situation in which the robot device R1 is caused to perform the task of inserting the peg into the hole is assumed (FIGS. 6A to 6C). It is assumed that the fingertip portion R12 includes a gripper. It is assumed that the tactile sensors RS are disposed on the respective side surfaces of the gripping portion in the pair in the gripper facing each other (FIGS. 2A and 2B). As the first task, it is assumed that the hole provided in the target surface is searched for while the peg gripped by the gripper is brought into contact with the target surface. The goal of the first task is to get a state in which the distal end of the peg engages with the hole. That is, it is assumed that the distal end of the peg engages with the hole as a switching event. As the second task, inserting the peg into the hole that has been searched for is assumed. A goal of the second task is to achieve a state in which the peg is inserted into the hole up to a predetermined state. It is assumed that a vision-based tactile sensor (for example, DIGIT manufactured by Meta) is used as the tactile sensor RS, and preprocessing is applied to the obtained observation data before anomaly detection. It is assumed that a variational auto-encoder (VAE) is used as the anomaly detection model AD. In the first control model M1 and the second control model M2, it is assumed that the control command is derived using the estimation value p_{epeg} of the position (orientation) p_{peg} of the distal end of the peg. Hereinafter, for convenience of description, the suffix “e” may be given to the estimation value. It is assumed that a machine learning model generated by model-based reinforcement learning using the cross-entropy method (CEM) is adopted for the first control model M1, and a rule-based model (heuristic model) is adopted for the second control model M2.

### (Preprocessing)

In the vision-based tactile sensor, a plurality of reference points (markers) are provided within an observation range of the sensor, and each reference point is displaced according to a load. First, the control unit 11 calculates the optical flow by calculating a difference between the raw data (image data) obtained by the tactile sensor RS and reference data. The reference data is data when there is no load (no deformation). The optical flow indicates a difference (displacement) between a current position of each reference point and a reference position. Next, the control unit 11 obtains a non-rotational component d and a non-compression component r by executing natural-Helmholtz-Hogge decomposition (HHD) on the obtained optical flow. Subsequently, the control unit 11 calculates an average value F_{N} of normal force and an average value T_{N} of a torque in the entire operation by executing calculations of Equations (1) and (2) below for the obtained non-rotational component d and the obtained non-compressive component r.

$$\begin{matrix}[ Math . 1 ] & \\ {F}_{N} ∝ \frac{1}{S} {\int }_{S} \vec{∇} \cdot \vec{d} dS , \vec{∇} … GRADIENT OPERATOR & ( Equation 1 )\end{matrix}$$

$$\begin{matrix}[ Math . 2 ] & \\ {T}_{N} ∝ \frac{1}{S} {\int }_{S} \vec{∇} \times \vec{r} dS & ( Equation 2 )\end{matrix}$$

S indicates a region including each reference point, and dS indicates a surface element.

Further, the control unit 11 calculates spectrograms of the normal force and the torque by executing Fourier transform for the obtained average value F_{N} of the normal force and the obtained average value T_{N} of the torque. For example, when a sampling rate of the tactile sensor RS is 20 Hz, a spectrogram of 0 to 10 Hz can be obtained. The control unit 11 acquires the calculated spectrogram as the preprocessed target observation data 125. The control unit 11 may ignore a spectrum of 0 Hz in order to exclude a static action (for example, gripping force). At least one of the normal force and the torque may be omitted. The anomaly detection model AD (variational auto-encoder) may be obtained by collecting spectrograms in a normal state (when the first task is performed) and performing training using the collected spectrograms.

### (Orientation Estimation)

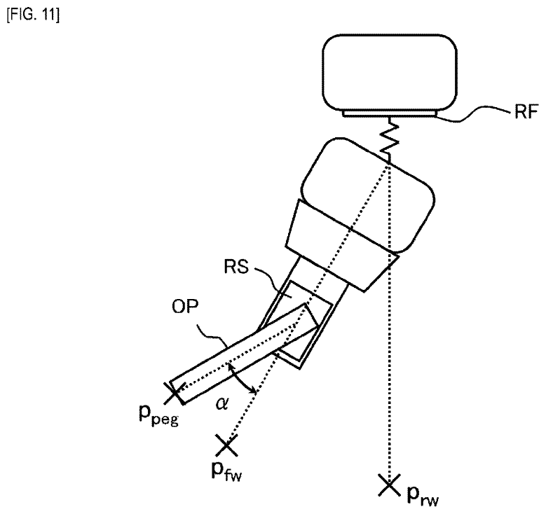

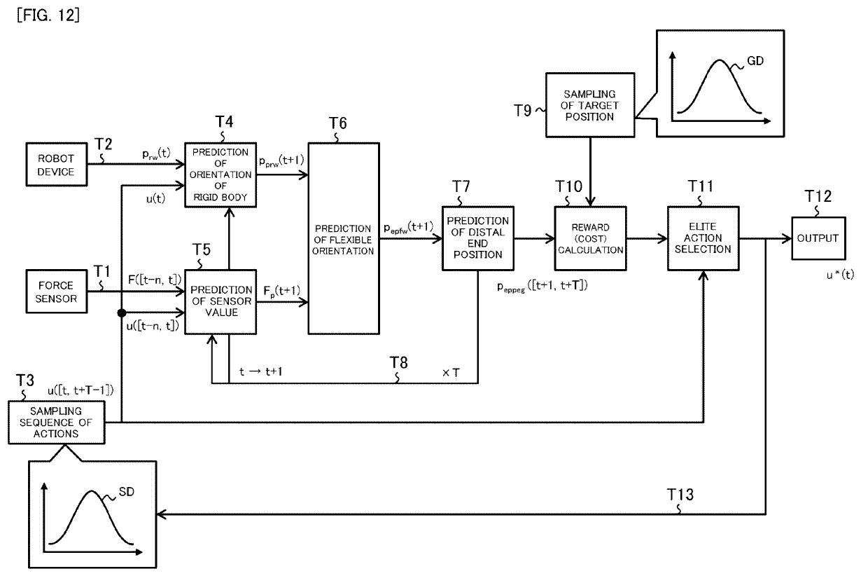

FIG. 11 schematically illustrates an example of a method of calculating an orientation of the fingertip (a distal end of a peg OP) of the robot device R1 according to the present embodiment. In the example of FIG. 11, p_{rw} indicates a distal end position of the peg OP (hereinafter also referred to as the position of the fingertip) when it is assumed that the peg OP is not inclined and the robot device R1 is a rigid body (the gripper is not displaced by the load). p_{fw} indicates the distal end position of the peg OP when the flexibility is considered. α denotes the inclination of the peg OP relative to the gripper.

In the example of FIG. 11, the force sensor RF is provided at the distal end of the arm, and the gripper is connected to the force sensor RF via a flexible portion. That is, in the example of FIG. 11, a portion (gripper) from the distal end of the arm has flexibility, and a load due to the flexibility is measured by the force sensor RF. Therefore, in the example of FIG. 11, a position p_{fw} of the fingertip having flexibility can be estimated from the measurement value of the force sensor RF. Specifically, an estimation value p_{efw} of the position p_{fw} of the fingertip having flexibility can be expressed as shown in Equation 3 below from Hooke's law.

[Math. 3]

p_{efw}=KF+p_{rw} (Equation 3)

F indicates a measurement value of the force and the torque obtained by the force sensor RF. The position p_{rw} of the fingertip of the rigid body is calculated from the state of the robot device R1 (for example, an angle of the joint and a dimension of each portion measured by the encoder). K is a learning target and can be expressed as in Equation 4 below.

[Math. 4]

K=(p_{lfw}−p_{rw})F* (Equation 4)

F* is a pseudo-inverse of F. P_{lfw} is a correct value (true value) of the position p_{fw} of the fingertip having flexibility at the corresponding value of F. A correct value p_{lfw} may be obtained appropriately. In one example, the correct value p_{lfw} may be obtained manually. In another example, the correct value p_{lfw} may be obtained by any computer processing such as motion capture or image analysis. A combination of a measurement value F of the force sensor RF, the position p_{rw} of the fingertip of the rigid body, and the correct value p_{lfw} may be collected appropriately. K may be calculated appropriately from the collected combinations (a plurality of samples) by fitting based on Equation 4. By obtaining K, the estimation value p_{efw} of the position p_{fw} of the fingertip having flexibility can be calculated according to Equation 3 above. K may be calculated by the control device 1 or may be calculated by a computer other than the control device 1.

Further, in the example of FIG. 11, since the tactile sensor RS is disposed on each of facing surfaces of gripping portions in the pair of the gripper, a load corresponding to the inclination a of the peg OP with respect to the gripper acts on the tactile sensor RS. Therefore, an estimation value (αₑ) of the inclination a of the peg OP can be calculated from the measurement value of the tactile sensor RS. The control unit 11 estimates the inclination a of the peg OP from the target observation data 125 of the tactile sensor RS. That is, the control unit 11 calculates the estimation value (αₑ) of the inclination of the peg OP from the target observation data 125. The control unit 11 may calculate the estimation value (αₑ) from the target observation data 125 before the preprocessing, or may calculate the estimation value (αₑ) from the target observation data 125 after the preprocessing is at least partially applied. The control unit 11 may apply preprocessing that is at least partially different from the preprocessing described above to the target observation data 125 in order to calculate the estimation value (αₑ).

A method of estimating the inclination of the peg OP is not particularly limited, and may be selected appropriately depending on an embodiment. In one example, when the vision-based tactile sensor is used as the tactile sensor RS, an elliptical shape corresponding to a gripping state of the peg OP appears in the target observation data 125 (raw image data). The control unit 11 may specify the elliptical shape through image processing and calculate the estimation value (αₑ) of the inclination of the peg OP from the inclination of the specified elliptical shape. When DIGIT is adopted for the tactile sensor RS, a known library such as OpenCV may be used for image processing.

The control unit 11 acquires the measurement value F directly or indirectly from the force sensor RF. The control unit 11 calculates the position p_{rw} of the fingertip of the rigid body based on the information from the robot device R1. The control unit 11 substitutes the obtained measurement value F, the position p_{rw} of the fingertip of the rigid body, and K obtained in advance by the learning into Equation 3 above and executes the calculation of Equation 3, thereby calculating the estimation value p_{efw} of the position p_{fw} of the fingertip having flexibility. The control unit 11 calculates the estimation value (αₑ) of the inclination of the peg OP from the target observation data 125. The control unit 11 calculates an estimation value (p_{epeg}) of the position p_{peg} of the distal end of the peg from the obtained estimation value (p_{efw} and de) as in Equation 5 below.

[Math. 5]

p_{epeg}=ƒ(p_{efw},αₑ) (Equation 5)

Conditions such as a size of the peg may be appropriately reflected in a function equation f.

### (Calculation and Update Processing of First Control Model)

FIG. 12 schematically illustrates an example of a calculation procedure of the first control model M1 in steps S106 and S107. In the example of FIG. 12, a situation is assumed in which a speed u(t) of the gripper, which is an action of the robot device R1, is determined at time t. The speed u corresponds to a target speed (velocity command value). Regarding the past from time t to n cycles before, a velocity sequence (u(t−n) to u(t−1)=u([t−n, t−1])) of the gripper and a measurement value sequence (F(t−n) to F(t−1)=F([t−n, t−1])) of the force sensor RF are held as histories to be accessible from the control unit 11.

In the example of FIG. 12, in step T1, the control unit 11 acquires the measurement value F(t) directly or indirectly from the force sensor RF. In step T2, the control unit 11 acquires the position p_{rw}(t) of the fingertip of the rigid body from the information from the robot device R1. In step T3, the control unit 11 samples a velocity sequence (u(t) to u(t+T−1)=u([t, t+T−1])) of the gripper for T cycles from a function equation that defines a distribution SD representing the action sequence. The value of T may be freely set. The velocity (action) u may be sampled from the distribution SD by using any method.

Further, at a freely-selected timing, the control unit 11 calculates the estimation value (αₑ) of the inclination of the peg OP from the target observation data 125. In one example, since the inclination of the peg OP is unlikely to change, the control unit 11 may repeatedly use the estimation value (αₑ) that has been calculated once. In another example, the control unit 11 may update the estimation value (αₑ) of the inclination of the peg OP by re-calculating the estimation value (αₑ) from the target observation data 125 at any timing.

In step T4, the control unit 11 calculates a prediction value pp_{rw}(t+1) of the position of the fingertip of the rigid body at time t+1 from the obtained p_{rw}(t) and u(t). The control unit 11 may predict a position (pp_{rw}(t+1)) of the fingertip of the rigid body at time t+1 according to Equation 6 below.

[Math. 6]

pₜ₊₁=pₜ+uΔt (Equation 6)

At indicates a time for one cycle. Δt may be given appropriately. The control unit 11 substitutes p_{rw}(t) as pₜ, substitutes u(t) as u, and executes the calculation of Equation 6, thereby obtaining a prediction value pp_{rw}(t+1). Hereinafter, for convenience of description, a suffix “p” may be given to the prediction value.

In step T5, the control unit 11 calculates a prediction value Fₚ(t+1) of the measurement value of the force sensor RF at time t+1 from a velocity sequence (u([t−n, t])) of the gripper for n cycles and the measurement value sequence (F([t−n, t])) of the force sensor RF using a prediction model. The prediction model may be implemented as any calculation model. The prediction model may be implemented as at least one of a machine learning model and a rule-based model. In one example, the prediction model may be implemented as a temporal convolutional network (TCN). By using the temporal convolutional network, the prediction model can efficiently learn long-term dependencies in parallel. The prediction model may be generated by using any method. Typically, the prediction model can be generated by supervised learning in which the velocity sequence of the gripper and the measurement value sequence of the force sensor RF for n cycles are used as training samples and a true value (teacher signal) of the measurement value of the force sensor RF in the next cycle is used.

In step T6, the control unit 11 substitutes the obtained Fₚ(t+1) as F, substitutes the prediction value pp_{rw}(t+1) of the position of the fingertip of the rigid body as p_{rw}, and executes the calculation of Equation 3 above. Thus, the control unit 11 calculates a prediction value p_{epfw}(t+1) of the position of the fingertip having flexibility at the time t+1. In step T7, the control unit 11 substitutes the obtained p_{epfw}(t+1) as p_{efw}, substitutes the estimation value (αₑ) of the inclination of the peg OP into Equation 5 above, and executes the calculation of Equation 5. Thus, the control unit 11 calculates a prediction value p_{eppeg}(t+1) of the distal end position of the peg at the time t+1. In the present specific example, a model including Equation 6 of step T4, a prediction model of step T5, Equation 3 of step T6, a model for estimating the inclination of the peg OP, and Equation 5 of step T7 is an example of the environmental model in the model-based reinforcement learning.

In step T8, the control unit 11 takes over the prediction result (pp_{rw}(t+1)) of step T4 and the prediction result (Fₚ(t+1)) of step T5, shifts from t to t+1, and executes the calculation from step T4 to step T7 again. The control unit 11 repeats the calculation from step T4 to step T7 T times in total to generate a prediction value sequence (p_{eppeg}([t+1, t+T])) of the peg distal end position. While the processing of step T4 to step T7 is repeated, the same values may be repeatedly used as the estimation value (αₑ) of the inclination of the peg OP.

In step T9, the control unit 11 samples the positions (estimation values) of the goal at each time point of t+1 to t+T from a function equation of a distribution GD of the positions of the holes (goals) into which the pegs are inserted. Thus, the control unit 11 generates a goal position sequence (pₜ([t+1, t+T])). Any distribution such as a Gaussian distribution may be used as the distribution GD. When the Gaussian distribution is adopted, the distribution GD may be defined by the mean u and the standard deviation σ (variance σ²) (these are also referred to as parameters). Hereinafter, it is assumed that a Gaussian distribution is adopted as the distribution GD. A value of each parameter of the distribution GD may be given appropriately depending on an embodiment. In one example, the value of each parameter of the distribution GD may be derived from conditions of task execution such as a variation in a position of a hole appearing in a camera image, and appropriately defined conditions of noise. The goal position (estimation value) pₜ may be sampled from the distribution GD by using any method.

In step T10, the control unit 11 substitutes the obtained goal position sequence (pₜ([t+1, t+T])) as pₜ, substitutes the prediction value sequence (p_{eppeg}([t+1, t+T])) of the distal end position of the peg as p_{epeg}, and substitutes Δu between the respective points in time calculated from the velocity sequence (u([t, t+T−1])) of the gripper to execute calculation of Equation 7 below. Accordingly, the control unit 11 calculates the cost J of the velocity sequence (u([t, t+T−1])) of the gripper generated in step T3.

$$\begin{matrix}[ Math . 7 ] & \\ J = {\sum }_{t + 1}^{r + T} {w}_{p} {‖ {p}_{t} ( t ) - {p}_{epeg} ( t ) ‖}^{2} + {w}_{u} Δ {u ( t )}^{2} & ( Equation 7 )\end{matrix}$$

wₚ and wᵤ are weights. Values of wₚ and wᵤ may be specified appropriately. The smaller the value of the cost J, the better the velocity sequence. The greater the change in acceleration in the velocity sequence of gripper, the greater the value of the term wᵤΔu. Therefore, since Equation 7 for calculating the cost J includes the term of wᵤΔu, it is possible to make it easy to select an action with a small change in acceleration.

In step T11, the control unit 11 executes calculation processing from step T3 to step T10 N times. The value of N may be freely set. The control unit 11 selects a velocity sequence having a small cost J from among N velocity sequences of the gripper. In one example, the control unit 11 selects the velocity sequence having the smallest cost J among the N velocity sequences. In the present specific example, a model including a function equation defining the distribution SD, a cost functions (Equation 7) in step T10, and the selection processing in step T11 is an example of the first control model M1. A statistic (feature quantity) that defines the distribution SD is an example of the calculation parameter. Any distribution such as a Gaussian distribution may be used as the distribution SD. When the Gaussian distribution is adopted, calculation parameters of the distribution SD may be an average value and a standard deviation (variance) of an action (in the present specific example, the speed u of the gripper). Hereinafter, it is assumed that a Gaussian distribution is adopted for the distribution SD.

In step T12, the control unit 11 adopts u(t) in the velocity sequence having the smallest cost J selected in step T11 as the velocity command value u*(t) at time t. The control unit 11 controls the operation of the robot device R1 (movement of the gripper) according to the adopted velocity command value u*(t). The series of processing of steps T3 to T12 is an example of the processing of step S106.

In step T13, the control unit 11 updates the distribution SD of the action space using at least one or more of the N velocity sequences obtained in step T11. The control unit 11 may preferentially use the velocity sequence having the smallest cost J. That is, the control unit 11 may select one or more velocity sequences in ascending order of the cost J from among the N velocity sequences, and update the distribution SD of the action space using the selected one or more velocity sequence. Accordingly, the control unit 11 updates values of the calculation parameters (for example, an average value and a standard deviation of the velocity) of the distribution SD. The processing of step T13 is an example of the processing of step S107.

In the present specific example, after controlling the operation of the robot device R1 in step T12, the control unit 11 acquires F(t+1) from the force sensor RF, and acquires the position p_{rw}(t+1) of the fingertip of the rigid body from the information from the robot device R1. The control unit 11 substitutes the obtained F(t+1) and p_{rw}(t+1) into Equation 3 above, and executes the calculation of Equation 3. Thus, the control unit 11 calculates an estimation value p_{efw}(t+1) of the position of the fingertip having flexibility at time t+1. Subsequently, the control unit 11 substitutes the obtained estimation value p_{efw}(t+1) and the estimation value (αₑ) of the inclination of the peg OP into Equation 5 above, and executes the calculation of Equation 5. Thus, the control unit 11 calculates an estimation value p_{epeg}(t+1) of the distal end position of the peg at the time t+1. The control unit 11 substitutes the obtained estimation value p_{epeg}(t+1), values of parameters of the distribution GD of the goal position (the average μ and the standard deviation σ), and a standard deviation ε of an error in orientation estimation of the peg OP to execute the calculation of Equation 8 below. Thus, the control unit 11 calculates a probability δ that the distal end of the peg OP is present at the position of the hole.

$$\begin{matrix}[ Math . 8 ] & \\ δ = exp ( - {\sum }_{i} \frac{{‖ {μ}_{i} - {p}_{epeg , i} ‖}^{2}}{2 {( {σ}_{i} + {ε}_{i} )}^{2}} ) & ( Equation 8 )\end{matrix}$$

i indicates a dimension. In the present specific example, since the distal end of the peg OP is moved while the distal end of the peg OP is brought into contact with the target surface, a degree of freedom of the distal end of the peg OP is a plane dimension (two dimensions). Therefore, i may correspond to a plane dimension (x, y). The standard deviation ε of the error in the orientation estimation of the peg OP is obtained in the process of calculating K. The standard deviation ε may be calculated from an error between p_{efw} estimated for each training sample and the correct value p_{lfw} of each training sample using K obtained by the learning.

Further, the control unit 11 applies the preprocessing to the target observation data 125 obtained in step S108 to obtain a spectrogram. In step S104, the control unit 11 inputs the obtained spectrogram to the variational auto-encoder (anomaly detection model AD) and executes calculation processing of the variational auto-encoder to obtain the restored data. The control unit 11 calculates a reconstruction error E by calculating a difference between the input data and the restored data. The control unit 11 substitutes the obtained probability δ, the reconstruction error E, and an evaluation value φ(t) of the previous cycle and executes calculation processing of Equation 9 below to calculate an evaluation value φ(t+1).

[Math. 9]

φ(t+1)=(1−l)φ(t)+kδE (Equation 9)

L and k may be freely given. Equation 9 is a leaky integrate-and-fire dynamic model. In one example, the control unit 11 may determine whether the tendency of the tactile sense is abnormal according to a result of comparison between an evaluation value φ(t+1) and a threshold value. The threshold value may be given appropriately.

In the present specific example, when the evaluation value φ(t+1) is less than a threshold value, the control unit 11 may determine that the tendency of the tactile sense is normal. In this case, the control unit 11 advances the processing to step S106 again. Specifically, since F(t+1) and p_{rw}(t+1) have already been acquired, the control unit 11 executes the processing again from step T3. On the other hand, when the evaluation value φ(t+1) exceeds the threshold value, the control unit 11 may determine that the tendency of the tactile sense is abnormal. In this case, the control unit 11 switches the task to be executed by the robot device R1 from the first task to the second task, and advances the processing to step S109. When the evaluation value φ(t+1) is equal to the threshold value, the control unit 11 may determine that the tendency of the tactile sense is normal or abnormal. The first step S104 may be freely processed. In one example, since there are no evaluation values φ(t) in the previous cycle, the control unit 11 may skip the processing of step S104 for the first time and advance the processing to step S106.

As in this specific example, the control unit 11 may calculate an evaluation value q of the output of the anomaly detection model AD using the leaky integrate-and-fire dynamic model, and determine whether the tendency of the tactile sense is abnormal based on the calculated evaluation value q. This can suppress erroneous detection that may occur when the output of the anomaly detection model AD temporarily indicates anomaly detection (in the present specific example, a value of the reconstruction error increases) due to an influence of noise or the like of the sensor value. Further, since the calculated evaluation value φ includes a probability δ of achieving the target of the first task (in the present specific example, the probability that the distal end of the peg OP is present at the position of the hole), it is possible to further increase the probability of anomaly detection. Therefore, in the present specific example, it is possible to expect improvement in the accuracy of anomaly detection by using the leaky integrate-and-fire dynamic model for calculation of the evaluation value φ of whether the tendency of the tactile sense by the anomaly detection model AD is abnormal and including the probability δ of achievement of the target of the first task in the evaluation value φ. These configurations may be adopted in embodiments other than the present specific example.

Further, in the present specific example, the control unit 11 may tune at least a part of the environment model online. In one example, the control unit 11 may acquire, as a true value, a measurement value F(t+1) obtained by the force sensor RF in the next cycle with respect to Fₚ(t+1) calculated in step T5 in the selected velocity sequence. The control unit 11 may update the prediction model of step T5 using the obtained true value. When the prediction model is implemented as a machine learning model such as a temporal convolutional network, the control unit 11 may combine the measurement value F(t+1) obtained as a true value with an input sample (the velocity sequence of the gripper and the measurement value sequence of the force sensor RF). By repeating this, the control unit 11 can obtain a plurality of data sets each of which includes a combination of the input sample and a true value. The control unit 11 may update the prediction model of step T5 by performing machine learning (supervised learning) using the plurality of obtained datasets. The machine learning may be executed at any timing. The machine learning may be executed by a computer other than the control device 1.

The processing order may be changed appropriately depending on an embodiment. Step T2 and T3 may be executed at any timing before step T4. Step T1 and step T3 may be executed at any timing before step T5. The order of steps T1 to T3 may be freely changed. Step T4 and step T5 may be executed at any timing before step T6. Step T5 may be performed before step T4. Step T9 may be executed at any timing before step T10. The order of step T12 and step T13 may be freely changed.

### (Control Process of Second Control Model)

FIG. 13 schematically illustrates an example of a control process of the second control model M2 in step S109. In the example of FIG. 13, rules of each step V1 to step V3 are heuristically determined.

First, in step V1, the control unit 11 moves the position p_{rw} of the fingertip of the rigid body (to be specific, the distal end R11A of the arm) in a horizontal direction using the estimation value (αₑ) of the inclination of the peg OP, thereby rotating the peg OP to be vertical. In the example of FIG. 13, the control unit 11 drives the robot device R1 so that the position of the fingertip of the rigid body moves from p_{rw}(1) to p_{rw}(2). Accordingly, the control unit 11 executes initial alignment of the peg OP.

When the alignment is performed, the control unit 11 may acquire the target observation data 125 from the tactile sensor RS at any timing, and calculate the estimation value (αₑ) of the inclination of the peg OP from the acquired target observation data 125. The control unit 11 may use the estimation value (αₑ) obtained when the first task is executed. Further, while the alignment is being performed, the control unit 11 may appropriately update the estimation value (αₑ) of the inclination of the peg OP by repeatedly executing these processing. When the alignment of the peg OP is completed, the control unit 11 performs the processing on the next step V2.

In step V2, the control unit 11 drives the robot device R1 so that the distal end R11A of the arm moves at a constant speed in a direction perpendicular to the target surface (a z-axis direction; a direction in which the hole extends). In this case, the control unit 11 does not move the distal end R11A of the arm in a horizontal direction (x and y directions), and a position of the distal end R11A of the arm in the horizontal direction (x and y directions) is preferably fixed. Accordingly, the control unit 11 controls the operation of the robot device R1 to insert the peg OP into the hole. The speed of insertion may be provided appropriately.

The control unit 11 appropriately calculates an estimation value p_{epeg} of the distal end position of the peg OP through the calculation of Equations 3 and 5 above. When a vertical component (z component) of the calculated estimation values p_{epeg} reaches a position deeper than a predetermined depth, the control unit 11 determines that the insertion of the peg OP into the hole is successful, and ends the processing of step S109. On the other hand, the vertical component (z component) of the calculated estimation values p_{epeg} may not reach the position deeper than the predetermined depth, and the peg OP may engage with the hole, so that the insertion of the peg OP is stopped (that is, jamming occurs). When the jamming occurs, the control unit 11 advances the processing to step V3.

The jamming may be detected by using any method. When the jamming occurs, the peg OP engages with the hole, and a large load is generated in a direction of repelling a movement in a vertical direction. The control unit 11 may detect the occurrence of jamming by detecting this load in the observation data (measurement value) of at least one of the tactile sensor RS and the force sensor RF.

In step V3, the control unit 11 drives the robot device R1 so that the distal end R11A of the arm moves in a horizontal direction (x and y directions) according to a rule defined in advance, thereby finely adjusting the angle of the peg OP (correction alignment of the peg OP). When the jamming is eliminated, the control unit 11 returns the process to step V2. The control unit 11 may detect the elimination of the jamming based on the observation data (measurement value) of at least one of the tactile sensor RS and the force sensor RF. When the jamming is not eliminated even if the fine adjustment of the angle of the peg OP is repeated, the control unit 11 determines that the insertion of the peg OP into the hole has failed, and ends the processing of step S109. Even when the vertical component (z component) of the calculated estimation values p_{epeg} does not reach the position deeper than the predetermined depth even if steps V2 and V3 are repeated, the control unit 11 determines that the insertion of the peg OP into the hole has failed, and ends the processing of step S109. The number of times of repetition may be determined appropriately. In the present specific example, a model including the rules of step V1 to step V3 is an example of the second control model M2.

### [Features]

In the present embodiment, the control unit 11 detects whether the tendency of the tactile sense acting on the fingertip portion R12 is abnormal by using the anomaly detection model AD through the processing of step S104. The control unit 11 switches the operation of the robot device R1 according to a result of detecting whether the tendency of the tactile sense is abnormal, by the processing of steps S105, S106, and S109. In step S104, by using the anomaly detection scheme (anomaly detection model AD), the timing of switching the operation can be accurately specified even when there is a variation in the positional relationship of the target object. Therefore, in steps S105, S106, and S109, it is possible to expect improvement in the execution accuracy of the task involving contact while allowing variation in the positional relationship of the target object in the robot device R1.

### § 4 Modified Example

The embodiments of the present disclosure have been described above in detail, but the foregoing description is merely illustrative of the present disclosure in all respects. Various improvements or changes may be made to the embodiment appropriately. For example, the following changes are possible. Hereinafter, the same reference numerals are used for the same components as those in the embodiment, and the description of the same points as those in the embodiment is omitted appropriately. The following modified examples can be combined appropriately.

<4.1>

In the above embodiment, the identifier C may be omitted. Accordingly, the identifier data 71 may be omitted from information held by the storage unit 12. In a software configuration of the control device 1, the identification unit 112 may be omitted. In the processing procedure of the control device 1, the processing of step S102 may be omitted. In one example, the selection unit 113 may select a model to be used, using any method such as selection according to a rule. In another example, the selection unit 113 may be omitted in the software configuration of the control device 1. Accordingly, the processing of step S103 may be omitted in the processing procedure of the control device 1. In the above embodiment, the number of tasks to be executed by the robot device R1 may be two or may be three or more.

<4.2>

In the above embodiment, the number of the anomaly detection models AD, the first control models M1, and the second control models M2 may be one or more. In another example, at least one of the first control model M1 and the second control model M2 may be omitted. When the first control model M1 is omitted, the first control model data 75 may be omitted from the information held by the storage unit 12. When the second control model M2 is omitted, the second control model data 77 may be omitted from the information held by the storage unit 12. For models that are omitted, a selection process in step S103 may be omitted.

<4.3>

In the processing procedure of the control device 1 according to the embodiment, at least one of omission, replacement, and addition of steps may be performed.

For example, when the identifier C does not use the target observation data 125 for inference, the processing of step S102 need not be necessarily executed after step S101, and may be executed at any timing before the processing of step S103 is executed. The processing of step S103 may be executed at any timing before the processing of step S104 is executed. The control device 1 may start the processing from step S101 after executing the processing of step S106.

The processing of step S107 may be omitted. Accordingly, the learning processing unit 116 may be omitted from the software configuration of the control device 1. In the example of FIG. 10, update processing in step S107 is executed for each cycle. However, a frequency of executing the update processing of step S107 need not be limited to such an example. The update processing of step S107 may be executed at any timing. The update processing of step S107 may be executed by another computer.

When the second control model M2 is implemented as a machine learning model, the update processing may be executed also for the second control model M2, similarly to the first control model M1 of the above embodiment. The update processing of the second control model M2 may be executed after the processing of step S109 is executed. The update processing of the second control model M2 may be executed at any timing, similarly to the update processing of step S107. The update processing of the second control model M2 may also be executed by another computer.

<4.4>

In a processing procedure of the control device 1 according to the above embodiment, the control device 1 controls the operation of the robot device R1 through the processing of step S109 and step S106. However, the process of switching the operation of the robot device R1 is not limited to such an example. In another example, the process of controlling the operation of the robot device R1 may be executed by one or more computers other than the control device 1.

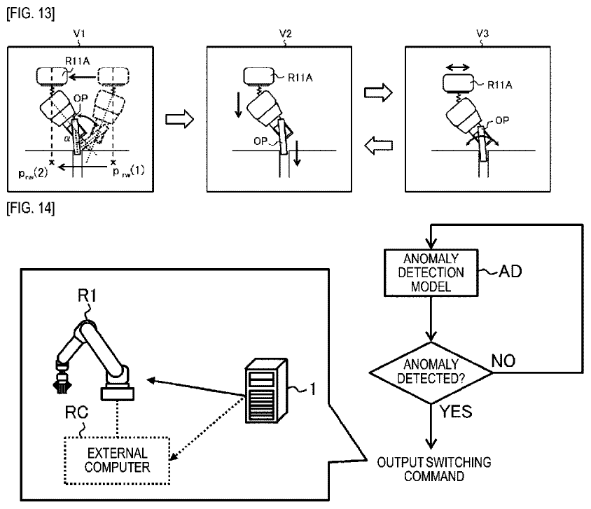

FIG. 14 schematically illustrates an example of a switching process according to another embodiment. In the present modified example, the control device 1 detects the occurrence of an event in accordance with whether the tendency of the tactile sense indicated by the acquired target observation data 125 is abnormal, using the anomaly detection model AD. The control device 1 may repeatedly execute an anomaly detection process until the anomaly of the tendency of the tactile sense is determined. The control device 1 determines the anomaly of the tendency of the tactile sense to give the command for switching the operation of the robot device R1 to the robot device R1 or an external computer RC in response to the detection of the occurrence of the event. That is, the operation switching unit 115 is configured to output the command for switching the operation of the robot device R1 to the robot device R1 or the external computer RC. The external computer RC may be appropriately configured to control the operation of the robot device R1. The external computer may be connected to the robot device R1 by using any method. A hardware configuration of the external computer may be the same as that of the control device 1.

FIG. 15 is a flowchart illustrating an example of the processing procedure of the control device 1 according to the present modified example. The following processing procedure is an example of a control method executed by a computer. However, the processing procedure of the control device 1 to be described below is merely an example, and each step may be changed as much as possible. Further, in the following processing procedure, steps can be omitted, replaced, and added appropriately depending on an embodiment.

The processing procedure of FIG. 15 may be the same as that of the above embodiment (FIG. 10) except that the processing of steps S106 and S107 is omitted and the processing of step S109 is replaced with the processing of step S201.

In step S201, the control unit 11 operates as the operation switching unit 115 and outputs the command for switching the operation of the robot device R1 to the robot device R1 or the external computer RC. Accordingly, the control device 1 switches the task to be executed by the robot device R1. The operation of the robot device R1 may be controlled by using any method. In one example, the robot device R1 or the external computer RC may control the operation of the robot device R1 so that the target task is executed, in the same manner as in the control device 1 according to the above embodiment. According to the present modified example, it is possible to expect improvement in execution accuracy of the task involving contact while allowing the variation in the positional relationship of the target object in a situation in which the operation of the robot device R1 is instructed (control of the operation of the robot device R1 is executed by another computer). In an overlapping range, a modified example regarding the processing procedure of the above embodiment (FIG. 10) may be applied to the processing procedure of FIG. 15.

### § 5 Examples

The following experiment was conducted to verify the effectiveness of the above embodiment. However, the present invention is not limited to the following examples.

### Examples

First, a UR5 manufactured by Universal Robot was used as the robot device. A force sensor was attached to the distal end of the arm. A flexible portion including three springs was added between the distal end of the arm and the gripper. A commercially available computer was used as the control device. As in the specific example, the insertion of the peg into the hole was adopted as a task to be performed by the robot device. As the first task, searching for the hole provided in the target surface while bringing the peg gripped by the gripper into contact with the target surface was adopted. For simplicity, a search direction was set to only one direction (y-axis direction). As a second task, inserting the peg into the hole that has been searched for was employed. A tolerances level of the peg and the hole was ISO H7/h7 (tolerances of up to 30 μm tolerances for the peg in 10 mm).

A tactile sensor was attached to one of fingers of the gripper. As the tactile sensor, DIGIT manufactured by Meta was used. The tactile sensor was set to stream 320×240p images at 20 FPS. The variational auto-encoder was adopted as the anomaly detection model. The design was made so that the preprocessing from the calculation of the optical flow to the calculation of the spectrogram in the specific example described above was applied to the observation data (image data) obtained by the tactile sensor before the observation data was input to the variational auto-encoder. For simplicity, the calculation of the normal force has been omitted. In the preprocessing, for the purpose of denoising, the vector field was scaled down to 1/25 by convolution and computed as a 12 9 matrix. The obtained torque was buffered with a sliding time window of 50 steps (2.5 seconds) and frequency was resolved into 26 bins from 0 to 10 Hz. This constituted the input to the variational auto-encoder by a spectrogram with length of 15 (15 26 matrix).

For the variational auto-encoder, an encoder and a decoder that were mirrored to each other were used. In the encoder, in order to process an input signal of the sliding spectrogram, a one-dimensional convolutional layer was used as an outer layer to filter redundant information, and then the data was compressed with three fully connected layers. Specifically, the encoder included a convolutional layer (the number of channels: 16, kernel size: 5, stride: 2) and three fully connected layers (the number of nodes: 32, 16, and 8). The decoder was constructed by mirroring the encoder.

According to an anomaly detection framework, the training samples of the spectrogram were collected by holding a peg with a 10 mm diameter on the gripper and sliding the peg on a metallic surface. A data collection period was 50 minutes and 60,000 samples were obtained. The obtained samples were used to train the variational auto-encoder. Training was completed after 200 epochs.

As a method of estimating the orientation of the peg, the method of the specific example (FIG. 11) was adopted. The correct value of the position of the fingertip having flexibility was measured by motion capture. 5000 samples were collected and a value of K was calculated from the collected samples. The resulting K was used to calculate the standard deviation ε of the error in the peg orientation estimation from the 5000 samples. ε was [5.48 mm, 5.15 mm, and 1.50 mm]. Further, the design is made such that an elliptical shape is specified by image processing using an OpenCV library with respect to image data obtained by the tactile sensor, and an inclination of the peg is estimated from the specified elliptical shape.

A model of the specific example (FIG. 12) was adopted as the first control model. The temporal convolutional network was adopted as the prediction model of step T5. The temporal convolutional network was configured to estimate the next cycle force/torque state from the past 20 force/torque states and the velocity sequence (a history for five seconds). The temporal convolutional network was constructed by stacking three TCN blocks (kernel size: 3 and the number of channels: 32), resulting in a receptive field with a length of 29. The temporal convolutional network was trained in real time with a batch of 500 items sampled from a history of past force/torque measurements. T was set to 6 steps (1.5 seconds). wₚ and wᵤ in Equation 7 were set to 1 and 0.01. Gaussian distributions were adopted for a distribution of action series and a distribution of the goal positions. The model in the specific example (FIG. 13) was adopted as the second control model. Values of l and k in Equation 9 were adjusted empirically. As a result, l and k were set to 0.9 and 2.5. The example was configured under the above conditions.

### Comparative Examples

In a comparative example, the tactile sensor and the anomaly detection model of the example were omitted. Then, by changing Equation 9 into Equation 10 below, a design was made to determine whether the search for the hole is completed from the probability δ that the distal end of the peg is present at the position of the hole without using the tactile sensor.

[Math. 10]

φB_{L}(t+1)=(1−l)φ_{BL}(t)+k(δ>δₜₕ) (Equation 10)

δₜₕ indicates a threshold value for δ. δₜₕ was set to 0.8 80%. The input (δ>δₜₕ) is expressed by two values. In the comparative example, l and k in Equation 10 were also adjusted empirically. As a result, l and k were set to 0.5 and 0.6. The other configurations were the same as those of the example.

### Experiments

For examples and comparative examples, 25 different environments were prepared based on the following conditions, and 20 trials were performed in each environment to calculate a success rate of the task of inserting the peg into the hole. Among the following conditions, the inclination of the peg was set at random within a range of each condition.

### (Conditions)

Diameter of peg: 5 mm, 10 mm, 15 mm
Uncertainty of position of goal (hole) (standard deviation σ): 2 mm, 5 mm, 8 mm, 10 mm
Inclination of peg relative to gripper: |α|<5°, 5°<|α|<20°

FIG. 16 shows experimental results of the examples and comparative examples. As illustrated in FIG. 16, in various environments, the examples exhibited a higher success rate than the comparative examples. Further, in environments of diameters of 5 mm and 15 mm of the peg that are not used for training of the anomaly detection model, the examples showed a high success rate. From this result, the effectiveness of the embodiment was verified.

The present specification includes the following disclosures.

### [Supplement 1]

A control device (1) for a robot device (R1) including a fingertip portion (R12) provided with a tactile sensor (RS), the control device including:
a storage unit configured to store an anomaly detection model (AD); and
a control unit (11),
wherein the control unit (11) is configured to execute:
acquiring target observation data (125) from the tactile sensor (RS); detecting occurrence of an event in accordance with whether a tendency of a tactile sense indicated by the acquired target observation data (125) is abnormal, using the anomaly detection model (AD); and
switching an operation of the robot device (R1) in accordance with detection of the occurrence of the event.

### [Supplement 2]

The control device (1) according to supplement 1, wherein
the storage unit further stores an identifier (C) for identifying a situation of the robot device (R1) from a plurality of situations,
the storage unit stores a plurality of the anomaly detection models (AD),
each of the plurality of anomaly detection models (AD) is prepared corresponding to each of the plurality of situations,
the control unit (11) is configured to further execute:
identifying a current situation of the robot device (R1) using the identifier (C); and
selecting an anomaly detection model (AD) to be used from among the plurality of anomaly detection models (AD) in accordance with a result of identifying the current situation, and
the detecting of the occurrence of the event includes detecting the occurrence of the event in accordance with whether the tendency of the tactile sense indicated by the acquired target observation data (125) is abnormal, using the selected anomaly detection model (AD).

### [Supplement 3]

The control device (1) according to supplement 2, wherein the identifier (C) is configured to identify the situation from observation data of the tactile sensor (RS), and
the identifying of the current situation includes identifying the current situation from the acquired target observation data (125) using the identifier (C).

### [Supplement 4]

The control device (1) according to any one of supplements 1 to 3, wherein
the switching of the operation of the robot device (R1) includes:
controlling an operation of the robot device (R1) so that a first task is performed until before the occurrence of the event is detected; and
controlling the operation of the robot device (R1) so that a second task is performed after detecting the occurrence of the event.

### [Supplement 5]

The control device (1) according to supplement 4, wherein the first task and the second task are defined so that an event in which a tendency of a tactile sense observed by the tactile sensor (RS) changes occurs during switching from the first task to the second task.

### [Supplement 6]

The control device (1) according to supplement 4 or 5,
wherein the anomaly detection model (AD) is configured to detect occurrence of the event as an anomaly from observation data of the tactile sensor (RS) obtained while the first task is being executed.

### [Supplement 7]

The control device (1) according to any one of supplements 4 to 6,
wherein
the storage unit further stores a first control model (M1) and a second control model (M2),
the first control model (M1) is given in accordance with the first task,
the second control model (M2) is given in accordance with the second task,
the controlling of the operation of the robot device (R1) so that the first task is executed includes controlling the operation of the robot device (R1) using the first control model (M1), and
the controlling of the operation of the robot device (R1) so that the second task is executed includes controlling the operation of the robot using the second control model (M2).

### [Supplement 8]

The control device (1) according to supplement 7, wherein
the storage unit further stores an identifier (C) for identifying a situation of the robot device (R1) from a plurality of situations,
the first task and the second task are defined for each of the situations,
the storage unit stores a plurality of the anomaly detection models (AD), a plurality of first control models (M1), and a plurality of second control models (M2),
each of the plurality of anomaly detection models (AD), each of the plurality of first control models (M1), and each of the plurality of second control models (M2) are prepared to correspond to each of the plurality of situations,
the control unit (11) is configured to further execute:
identifying a current situation of the robot device (R1) using the identifier (C); and
selecting an anomaly detection model (AD), a first control model (M1), and a second control model (M2) to be used from among the plurality of anomaly detection models (AD), the plurality of first control models (M1), and the plurality of second control models (M2) in accordance with a result of identifying the current situation,
the detecting of the occurrence of the event includes detecting the occurrence of the event in accordance with whether the tendency of the tactile sense indicated by the acquired target observation data (125) is abnormal, using the selected anomaly detection model (AD),
the using of the first control model (M1) includes using the selected first control model (M1), and
the using of the second control model (M2) includes using the selected second control model (M2).

### [Supplement 9]

The control device (1) according to supplement 8, wherein
the identifier (C) is configured to identify the situation from observation data of the tactile sensor (RS), and
the identifying of the current situation includes identifying the current situation from the acquired target observation data (125) using the identifier (C).

### [Supplement 10]

The control device (1) according to any one of supplements 7 to 9, wherein the first control model (M1) is implemented as a machine learning model.

### [Supplement 11]

The control device (1) according to supplement 10, wherein
the first control model (M1) is generated by model-based reinforcement learning using a cross-entropy method, and
the machine learning model implemented as the first control model (M1) includes a function equation that defines a distribution representing an action space.

### [Supplement 12]

The control device (1) according to any one of supplements 7 to 11, wherein the second control model (M2) is implemented as a rule-based model.

### [Supplement 13]

The control device (1) according to any one of supplements 4 to 12, wherein
the fingertip portion (R12) includes an end effector,
the first task is to search for a hole (H21) provided in a target surface (O21) of a second target object (O2) while bringing a first target object (O1) held by the end effector into contact with the target surface (21), and
the second task is to insert the first target object (O1) into the hole (H21) that has been searched for.

### [Supplement 14]

The control device (1) according to any one of supplements 1 to 13, wherein the robot device (R1) has flexibility.

### [Supplement 15]

The control device (1) according to any one of supplements 1 to 3, wherein the switching of the operation of the robot device (R1) includes outputting a command for switching the operation of the robot device (R1) to the robot device (R1) or an external computer configured to control the operation of the robot device (R1).

### [Supplement 16]

A control program for causing a computer (1) to execute:
acquiring target observation data (125) from a tactile sensor (RS) provided in a fingertip portion (R12) of a robot device (R1);
detecting occurrence of an event in accordance with whether a tendency of a tactile sense indicated by the acquired target observation data (125) is abnormal, using an anomaly detection model (AD); and
switching an operation of the robot device (R1) in accordance with the detection of the occurrence of the event.

### [Supplement 17]

A control method including:
acquiring, by a computer (1), target observation data (125) from a tactile sensor (RS) provided in a fingertip portion (R12) of a robot device (R1);
detecting, by the computer (1), occurrence of an event in accordance with whether a tendency of a tactile sense indicated by the acquired target observation data (125) is abnormal, using an anomaly detection model (AD); and
switching, by the computer (1), an operation of the robot device (R1) in accordance with the detection of the occurrence of the event.

### DESCRIPTION OF SYMBOLS

1 control device
11 control unit
12 storage unit
13 external interface
14 input device
15 output device
16 drive
81 control program
91 storage medium
111 acquisition unit
112 identification unit
113 selection unit
114 anomaly detection unit
115 operation switching unit
116 learning processing unit
125 target observation data
C identifier
71 identifier data
AD anomaly detection model
73 anomaly detection model data
M1 first control model
75 first control model data
M2 second control model
77 second control model data
R1 robot device
R12 fingertip portion
RS tactile sensor
RF force sensor

1. A control device for a robot device including a fingertip portion provided with a tactile sensor, the control device comprising:
a storage unit configured to store an anomaly detection model; and
a control unit,
wherein the control unit is configured to execute:
acquiring target observation data from the tactile sensor;
detecting occurrence of an event in accordance with whether a tendency of a tactile sense indicated by the acquired target observation data is abnormal, using the anomaly detection model; and
switching an operation of the robot device in accordance with detection of the occurrence of the event.

2. The control device according to claim 1, wherein
the storage unit further stores an identifier for identifying a situation of the robot device from a plurality of situations,
the storage unit stores a plurality of the anomaly detection models,
each of the plurality of anomaly detection models is prepared corresponding to each of the plurality of situations,
the control unit is configured to further execute:
identifying a current situation of the robot device using the identifier; and
selecting an anomaly detection model to be used from among the plurality of anomaly detection models in accordance with a result of identifying the current situation, and
the detecting of the occurrence of the event includes detecting the occurrence of the event in accordance with whether the tendency of the tactile sense indicated by the acquired target observation data is abnormal, using the selected anomaly detection model.

3. The control device according to claim 2, wherein
the identifier is configured to identify the situation from observation data of the tactile sensor, and
the identifying of the current situation includes identifying the current situation from the acquired target observation data, using the identifier.

4. The control device according to claim 1, wherein
the switching of the operation of the robot device includes:
controlling an operation of the robot device so that a first task is executed until before the occurrence of the event is detected; and
controlling the operation of the robot device so that a second task is executed after detecting the occurrence of the event.

5. The control device according to claim 4, wherein the first task and the second task are defined so that an event in which a tendency of a tactile sense observed by the tactile sensor changes occurs during switching from the first task to the second task.

6. The control device according to claim 5, wherein the anomaly detection model is configured to detect occurrence of the event as an anomaly from observation data of the tactile sensor obtained while the first task is being executed.

7. The control device according to claim 4, wherein
the storage unit further stores a first control model and a second control model,
the first control model is given in accordance with the first task,
the second control model is given in accordance with the second task,
the controlling of the operation of the robot device so that the first task is executed includes controlling the operation of the robot device using the first control model, and
the controlling of the operation of the robot device so that the second task is executed includes controlling the operation of the robot using the second control model.

8. The control device according to claim 7, wherein
the storage unit further stores an identifier for identifying a situation of the robot device from a plurality of situations,
the first task and the second task are defined for each of the situations,
the storage unit stores a plurality of the anomaly detection models, a plurality of first control models, and a plurality of second control models,
each of the plurality of anomaly detection models, each of the plurality of first control models, and each of the plurality of second control models are prepared to correspond to each of the plurality of situations,
the control unit is configured to further execute:
identifying a current situation of the robot device using the identifier; and
selecting an anomaly detection model, a first control model, and a second control model to be used from among the plurality of anomaly detection models, the plurality of first control models, and the plurality of second control models in accordance with a result of identifying the current situation,
the detecting of the occurrence of the event includes detecting the occurrence of the event in accordance with whether the tendency of the tactile sense indicated by the acquired target observation data is abnormal, using the selected anomaly detection model,
the using of the first control model includes using the selected first control model, and
the using of the second control model includes using the selected second control model.

9. The control device according to claim 8, wherein
the identifier is configured to identify the situation from observation data of the tactile sensor, and
the identifying of the current situation includes identifying the current situation from the acquired target observation data using the identifier.

10. The control device according to claim 7, wherein the first control model is implemented as a machine learning model.

11. The control device according to claim 10, wherein
the first control model is generated by model-based reinforcement learning using a cross-entropy method, and
the machine learning model implemented as the first control model includes a function equation that defines a distribution representing an action space.

12. The control device according to claim 7, wherein the second control model is implemented as a rule-based model.

13. The control device according to claim 7, wherein
the fingertip portion includes an end effector,
the first task is to search for a hole provided in a target surface of a second target object while bringing a first target object held by the end effector into contact with the target surface, and
the second task is to insert the first target object into the hole that has been searched for.

14. The control device according to claim 13, wherein the robot device has flexibility.

15. The control device according to claim 1, wherein the switching of the operation of the robot device includes outputting a command for switching the operation of the robot device to the robot device or an external computer configured to control the operation of the robot device.

16. A non-transitory storage medium storing a control program for causing a computer to execute:
acquiring target observation data from a tactile sensor provided in a fingertip portion of a robot device;
detecting occurrence of an event in accordance with whether a tendency of a tactile sense indicated by the acquired target observation data is abnormal, using an anomaly detection model; and
switching an operation of the robot device in accordance with the detection of the occurrence of the event.

17. A control method comprising:
acquiring, by a computer, target observation data from a tactile sensor provided in a fingertip portion of a robot device;
detecting, by the computer, occurrence of an event in accordance with whether a tendency of a tactile sense indicated by the acquired target observation data is abnormal, using an anomaly detection model; and
switching, by the computer, an operation of the robot device in accordance with the detection of the occurrence of the event.
